(19) United States
(12) Patent Application Publication
(10) Pub. No.: US 2009/0310060 A1
(43) Pub. Date: Dec. 17, 2009

(54) OPTICAL PACKAGE, METHOD OF MANUFACTURING THE SAME, BACKLIGHT, AND LIQUID CRYSTAL DISPLAY

(75) Inventors: Miki Sudo, Miyagi (JP); Eiji Ohta, Miyagi (JP); Tatsuya Harima, Miyagi (JP); Shogo Shinkai, Miyagi (JP); Taro Omura, Miyagi (JP); Kazuhiro Okamoto, Miyagi (JP); Akiko Kakibe, Miyagi (JP); Masayasu Kakinuma, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/482,109

(22) Filed: Jun. 10, 2009

(30) Foreign Application Priority Data
Jun. 13, 2008 (JP) 2008-156045

(51) Int. Cl. G02B 7/02; G09F 13/04; G02F 1/1333

(52) U.S. Cl. 349/58; 359/811; 362/97.1; 156/85

(57) ABSTRACT

An optical package includes one or two or more film-like or sheet-like optical elements, a plate-like support which supports the one or two or more optical elements, and a film-like or sheet-like packaging member which covers the one or two or more optical elements and the support. The one or two or more optical elements and the support form a stack, the stack and the packaging member are in close contact with each other, and the packaging member has a shrinkage property or a stretching property and contains voids and a filler disposed in the voids.

### CROSS REFERENCES TO RELATED APPLICATIONS

The present application claims priority to Japanese Priority Patent Application JP 2008-156045 filed in the Japan Patent Office on Jun. 13, 2008, the entire content of which is hereby incorporated by reference.

### BACKGROUND

The present application relates to an optical package, a method of manufacturing the same, a backlight, and a liquid crystal display. More particularly, the present application relates to an optical package having diffusing properties.

In liquid crystal displays according to the related art, many optical elements are used for the purpose of improving viewing angle, luminance, etc. As the optical elements, for example, film-like or sheet-like elements, such as a diffuser film and a prism sheet, are used.

FIG. 29 shows a structure of a liquid crystal display according to the related art. As shown in FIG. 29, the liquid crystal display includes an illuminating device 101 which emits light, a diffuser plate 102 which diffuses the light emitted from the illuminating device 101, a plurality of optical elements 103 which condense or diffuse the light diffused by the diffuser plate 102, and a liquid crystal panel 104.

In recent years, as the size of image display apparatuses has been increasing, the areas of illuminating devices have also been increasing, which has necessitated an increase in the areas of various optical elements. However, when the areas of the optical elements are increased, wrinkles, deflection, and warpage tend to occur due to their own weight. Furthermore, as the areas increase, illuminance of light sources is increased so that the display surface brightness can be maintained. Consequently, the amount of heat applied to the surfaces of the optical elements, the areas of which have been increased, increases. Since heat is transmitted nonuniformly to the surfaces of the optical elements, thermal deformation of the optical elements does not occur uniformly. Therefore, wrinkles, deflection, and warpage also tend to occur due to heat.

In order to prevent the occurrence of wrinkles, deflection, and warpage in optical elements due to the increase in the size of screens, for example, a method may be conceived in which, by increasing the thickness of the optical elements, rigidity is improved such that it is no longer insufficient. However, in such a case, the thickness of the illuminating devices increases, thus inhibiting the reduction in thickness. Therefore, for example, as described in Japanese Unexamined Patent Application Publication No. 2005-301147, a structure is conceivable in which optical elements are wholly bonded together in the order of stacking using a transparent adhesive. By stacking optical elements using a transparent adhesive, the rigidity of the optical elements can be enhanced, and wrinkles, deflection, and warpage can be prevented from occurring.

### SUMMARY

However, in the structure in which optical elements are simply bonded together by using a transparent adhesive, the thickness of the apparatus is increased by the thickness of the transparent adhesive, which may inhibit the reduction in thickness. Furthermore, in the case where the optical elements have different thermal expansion coefficients, when the light source is turned on, the optical elements are heated due to heat from the light source and thermally expand at different rates. When the light source is turned off and heat is not supplied from the light source, the optical elements cool and thermally shrink at different rates. In the case where the optical elements repeatedly expand and shrink as described above, when the optical elements are bonded together, there is a possibility that deflection and warpage may occur in the optical elements, resulting in degradation of optical properties.

It is desirable to provide an optical package in which wrinkles, deflection, and warpage are prevented from occurring in optical elements, reduction in thickness can be achieved, and satisfactory optical properties can be obtained, as well as a method of manufacturing the same, a backlight, and a liquid crystal display.

The present inventors have diligently conducted research in order to solve the problems associated with the related art described above, and a summary thereof will be described below.

The present inventors have diligently conducted research in order to improve rigidity of optical, elements and to prevent the occurrence of wrinkles, deflection, and warpage in the optical elements while suppressing the increase in the thickness of the liquid crystal display and the degradation of display properties of the liquid crystal display. As a result, the following optical packages have been invented:

(1) An optical package in which a stack including a film-like or sheet-like optical element and a plate-like support is covered with a film-like or sheet-like packaging member, and the packaging member and the stack are brought into close contact with each other,

(2) An optical package in which an optical functional layer and a lens are formed on the surface of a film-like or sheet-like packaging member, a plate-like support is covered with the packaging member provided with the optical function, and the packaging member and the support are brought into close contact with each other.

In an optical package, by diffusing Sight emitted from a light source by using a diffuser plate, a diffuser film, or the like which is used as a support, non-uniformity of the light source is eliminated. Furthermore, in such a structure, the luminance and viewing angle necessary for the liquid crystal display are obtained.

However, when a structure is employed in which the thickness of the backlight is further decreased in response to a demand for further reduction in thickness of the liquid crystal display, the distance between a light source, such as a cold cathode fluorescent lamp (CCFL), and an optical package is shortened, and therefore, it is difficult to eliminate the non-uniformity of the light source, such as a cold cathode fluorescent lamp, which is a problem. As a result, it is difficult to obtain satisfactory optical properties.

In order to solve such a problem, it is necessary to increase the number of optical elements capable of eliminating the non-uniformity of the light source in the optical package. However, if the number of optical elements is increased, the thickness of the optical package itself increases. Furthermore, because of an increase in the number of optical elements, in some cases, the luminance may be decreased.

As a result of research by the present inventors, it has been found that by incorporating voids and a filler disposed in the voids into a packaging member so that a diffusion function can be imparted to the packaging member, necessary optical properties (light source uniformity, luminance, viewing angle, and the like.) can be obtained without increasing the number of optical elements.

Based on this research, an optical package according to an embodiment is provided. The optical package includes one or two or more film-like or sheet-like optical elements, a plate-like support which supports the one or two or more optical elements, and a film-like or sheet-like packaging member which covers the one or two or more optical elements and the support, in which the one or two or more optical elements and the support form a stack, the stack and the packaging member are in close contact with each other, and the packaging member has a shrinkage property or a stretching property and contains voids and a filler disposed in the voids.

An optical package according to another embodiment includes a plate-like support and a film-like or sheet-like packaging member which covers the support, in which the packaging member and the support are in close contact with each other, and the packaging member has a shrinkage property or a stretching property and contains voids and a filler disposed in the voids.

A method of manufacturing an optical package according to another embodiment includes forming a film-like or sheet-like packaging member which contains a binder and a filler, forming voids in the packaging member so that the voids include the filler by stretching the packaging member, covering a stack including one or two or more film-like or sheet-like optical elements and a plate-like support with the stretched packaging member, and bringing the stack and the packaging member into close contact with each other by shrinking the packaging member.

A method of manufacturing an optical package according to another embodiment includes forming a film-like or sheet-like packaging member which contains a binder and a filler, forming voids in the packaging member so that the voids include the filler by stretching the packaging member, covering a plate-like support with the stretched packaging member, and bringing the support and the packaging member into close contact with each other by shrinking the packaging member.

A backlight according to another embodiment includes a light source which emits light and an optical package through which the light emitted from the light source is transmitted, in which the optical package includes one or two or more film-like or sheet-like optical elements, a plate-like support which supports the one or two or more optical elements, and a film-like or sheet-like packaging member which covers the one or two or more optical elements and the support, in which the one or two or more optical elements and the support form a stack, the stack and the packaging member are in close contact with each other, and the packaging member has a shrinkage property or a stretching property and contains voids and a filler disposed in the voids.

A backlight according to another embodiment includes a light source which emits light and an optical package through which the light emitted from the light source is transmitted, in which the optical package includes a plate-like support and a film-like or sheet-like packaging member which covers the support, in which the packaging member and the support are in close contact with each other, and the packaging member has a shrinkage property or a stretching property and contains voids and a filler disposed in the voids.

A liquid crystal display according to another embodiment includes a light source which emits light, an optical package through which the light emitted from the light source is transmitted, and a liquid crystal panel which displays an image on the basis of the light transmitted through the optical package, in which the optical package includes one or two or more film-like or sheet-like optical elements, a plate-like support which supports the one or two or more optical elements, and a film-like or sheet-like packaging member which covers the one or two or more optical elements and the support, in which the one or two or more optical elements and the support form a stack, the stack and the packaging member are in close contact with each other, and the packaging member has a shrinkage property or a stretching property and contains voids and a filler disposed in the voids.

A liquid crystal display according to another embodiment includes a light source which emits light, an optical package through which the light emitted from the light source is transmitted, and a liquid crystal panel which displays an image on the basis of the light transmitted through the optical package, in which the optical package includes a plate-like support and a film-like or sheet-like packaging member which covers the support, in which the packaging member and the support are in close contact with each other, and the packaging member has a shrinkage property or a stretching property and contains voids and a filler disposed in the voids.

According to an embodiment, since the one or two or more optical elements and the support are covered with the packaging member, the one or two or more optical elements and the support can be integrated with each other. Consequently, the insufficient rigidity of the optical elements can be compensated for by the support. Furthermore, the optical elements and the support are covered with the packaging member in the presence of shrinkage force (tension). By allowing the optical package itself to have tension, even when a thin packaging member is used, the packaging member can be placed without being deflected. Thus, it is possible to prevent the occurrence of wrinkles, deflection, and warpage in the packaging member and the optical elements.

According to an embodiment, the support is covered with the packaging member in the presence of shrinkage force (tension), and by allowing the optical package itself to have tension, even when a thin packaging member is used, the packaging member can be placed without being deflected. Thus, it is possible to prevent the occurrence of wrinkles and deflection in the packaging member.

According to an embodiment, since the packaging member contains voids and the filler disposed in the voids, a diffusion function can be imparted to the packaging member. Consequently, the packaging member can be used as a replacement for the existing film having a diffusion function (e.g., a diffuser film), and the thickness of the optical package itself can be decreased.

As described above, according to an embodiment, while preventing the occurrence of wrinkles, deflection, and warpage in the optical package, reduction in thickness can be achieved compared with the case where a diffuser film is included in a packaging member, and satisfactory optical properties can be obtained.

Additional features and advantages are described herein, and will be apparent from the following Detailed Description and the figures.

### BRIEF DESCRIPTION OF THE FIGURES

FIG. 1 is a schematic view showing an example of a structure of a liquid crystal display according to a first embodiment;

FIG. 2 is a perspective view showing a first example of a structure of an optical package according to the first embodiment;

FIG. 3A is a plan view showing the first example of the structure of the optical package according to the first embodiment, and FIG. 3B is a cross-sectional view taken along the line IIIB-IIIB of FIG. 3A;

FIG. 4 is a cross-sectional view showing a first example of a junction portion of a packaging member according to the first embodiment,

FIG. 5 is a cross-sectional view showing a second example of the junction portion of the packaging member according to the first embodiment;

FIG. 6 is a perspective view showing a second example of a structure of the optical package according to the first embodiment;

FIG. 7 is a perspective view showing a third example of the structure of the optical package according to the first embodiment;

FIG. 8 is an enlarged view showing part of a packaging member according to the first embodiment;

FIG. 9A is a cross-sectional view showing a first example of a structure of the packaging member according to the first embodiment, taken along the line IXA-IXA of FIG. 8, and FIG. 9B is a cross-sectional view showing the first example of the structure of the packaging member according to the first embodiment, taken along the line IXB-IXB of FIG. 8;

FIG. 10A is a cross-sectional view showing a second example of the structure of the packaging member according to the first embodiment, taken along the line IXA-IXA of FIG. 8, and FIG. 10B is a cross-sectional view showing the second example of the structure of the packaging member according to the first embodiment, taken along the line IXB-IXB of FIG. 8;

FIG. 11 is a cross-sectional view showing a third example of the structure of the packaging member according to the first embodiment;

FIG. 12 is a cross-sectional view showing a fourth example of the structure of the packaging member according to the first embodiment;

FIG. 13 is a cross-sectional view showing a fifth example of the structure of the packaging member according to the first embodiment;

FIG. 14 is a cross-sectional view showing a sixth example of the structure of the packaging member according to the first embodiment;

FIG. 15 is a cross-sectional view showing a seventh example of the structure of the packaging member according to the first, embodiment;

FIG. 16 is a cross-sectional view showing an eighth example of the structure of the packaging member according to the first embodiment;

FIG. 17 is a cross-sectional view showing a ninth example of the structure of the packaging member according to the first embodiment;

FIG. 18A is a cross-sectional view showing a tenth example of the structure of the packaging member according to the first embodiment, and FIG. 18B is an enlarged view of a region indicated by XVIIIB in FIG. 18A;

FIGS. 19A to 19D are schematic views showing a method of manufacturing an optical package according to the first embodiment;

FIGS. 20A to 20C are schematic views showing a method of manufacturing the optical package according to the first embodiment;

FIG. 21 is a schematic view showing an example of a structure of a liquid crystal display according to a second embodiment;

FIG. 22 is a perspective view showing an example of a structure of an optical package according to the second embodiment;

FIG. 23A is a plan view showing an example of a structure of the optical package according to the second embodiment, and FIG. 23B is a cross-sectional view taken along the line XXIIIB-XXIIIB of FIG. 23 A;

FIG. 24 is a schematic view showing an example of a structure of a liquid crystal display according to a third embodiment;

FIG. 25A is a plan view showing an example of a structure of a backlight according to the third embodiment, and FIG. 25B is a cross-sectional view taken along the line XXVB-XXVB of FIG. 25A;

FIG. 26 is a schematic view showing a first example of a structure of an optical package according to the third embodiment;

FIG. 27 is a schematic view showing a second example of the structure of the optical package according to the third embodiment;

FIGS. 28A and 28B are a plan view and a perspective view, respectively, of an optical package according to a fourth embodiment; and

FIG. 29 is a schematic view showing a liquid crystal display according to the related art.

### DETAILED DESCRIPTION

The present application will be described below in greater detail with reference to the drawings according to an embodiment. In the drawings according to the embodiments, the same reference numerals are used to designate the same or corresponding components.

### (1) First Embodiment

### (1-1) Structure of Liquid Crystal Display

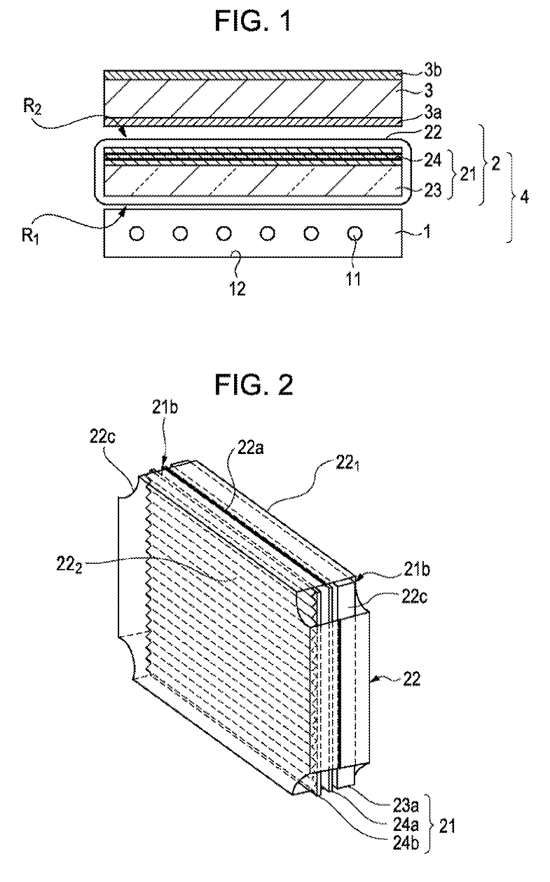

FIG. 1 is a schematic view showing an example of a structure of a liquid crystal display according to a first embodiment. As shown in FIG. 1 the liquid crystal display includes an illuminating device 1 which emits light, an optical package 2 through which the light emitted from the illuminating device 1 is transmitted, and a liquid crystal panel 3 which displays an image on the basis of the light transmitted through the optical package 2. The illuminating device 1 and the optical package 2 constitute a backlight 4. Hereinafter, with respect to surfaces of an optical member, such as the optical package 2, a surface on which the light from the illuminating device 1 is incident is referred to as an “light-incident surface”, a surface from which the light incident on the light-incident surface is emitted is referred to as a “light-emitting surface”, and a surface located between the light-incident surface and the light-emitting surface h referred to as an “end face”. The light-incident surface and the light-emitting surface are collectively referred to as “principal surfaces”, as appropriate.

### (Illuminating Device)

The illuminating device 1 is, for example, a direct-type illuminating device, and includes a light source 11 which emits light and a reflector 12 which reflects the light emitted from the light source 11 such that the light is directed toward the liquid crystal panel 3. As the light source 11, for example, a cold cathode fluorescent lamp (CCFL), a hot cathode fluorescent lamp (HCFL), an organic electroluminescence (OEL) device, a light-emitting diode (LED), an inorganic electroluminescence (IEL) device, or the like may be used. The reflector 12 is disposed so as to cover the bottom and side of one or a plurality of light sources 11, and reflects the light emitted downward and laterally from the one or the plurality of light sources 11 so that the light is directed toward the liquid crystal panel 3.

### (Optical Package)

The optical package 2 includes, for example, one or a plurality of optical elements 24 which diffuse, condense, or otherwise process the light emitted from the illuminating device 1 so that the optical properties are changed, a support 23 which supports the one or the plurality of optical elements 24, and a packaging member 22 which covers and integrates the one or the plurality of optical elements 24 and the support 23. Hereinafter, a structure in which the one or the plurality of optical elements 24 are stacked on the support 23 is referred to as an “optical element stack 21”. From the standpoint of suppressing degradation of images, preferably, the optical element stack 21 is in close contact, with the packaging member 22. The packaging member 22 has a first region R₁ through which light entering the optical element stack 21 is transmitted, and a second region R₂ through which light emitted from the optical element stack 21 is transmitted.

### (Optical Element)

The number or type of the optical elements 24 is not particularly limited and can be appropriately selected according to the desired characteristics of the liquid crystal display. As the optical element 24, for example, an element at least acting as a support and having an optical function, or an element acting as a support and having one or a plurality of optical functions may be used. Examples of the optical elements 24 that can be used include a light diffusion element, a light-condensing element, a reflective polarizer, a polarizer, a light-splitting element, and the like. The optical elements 24 may be, for example, film-like, sheet-like, or plate-like. The thickness of the optical elements 24 is, for example, 5 to 1,000 μm.

### (Support)

The support 23 has, for example, a plate-like shape The support 23 is, for example, a transparent plate which transmits light emitted from the illuminating device 1, or an optical plate which diffuses, condenses, or otherwise processes light emitted from the illuminating device 1 so that the optical properties are changed. As the optical plate, for example, a diffuser plate, a retardation plate, a prism plate, or the like may be used. The thickness of the support 23 is preferably 50 to 10,000 μm, and more preferably 100 to 5,000 μm. Preferably, the thickness, section width, length, and rigidity (elastic modulus) of the support 23 are appropriately selected in consideration of the tension of the packaging member 22.

The presence or absence of tension can be confirmed and the tension can be measured, for example, by the method described below. Using a TMA (thermal stress strain measurement apparatus EXSTAR6000 TMA/SS) manufactured by Seiko Instruments Inc., the tension of the packaging member 22 is measured as follows. First, in the state in which a tension is applied to the packaging member 22, a test piece with a size of 5 mm×50 mm is cut out from the center of the optical package, using a rectangular die, such that the long side and the short side of the test piece are respectively parallel to the long side and the short, side of a diffuser plate serving as a support. Next, the test piece is sandwiched between glass plates such that no looseness occurs, and then, the length is measured with a tool microscope manufactured by Topcon Corporation. In the cut-out test piece, tension is released, and therefore, the test piece shrinks from 50 mm. The dimension is converted such that the state of being shrunk is returned to the initial length of 50 mm, and a test piece for TMA is cut out again. The cut-out test piece is set in the apparatus. The tension at an initial temperature of 25° C. is measured. Any tension measurement apparatus can be used as long as it can apply a tensile stress to a predetermined length and measure the stress, thus enabling confirmation of the presence or absence of tension.

Specifically, with respect to the support 23, in the case of a direct-type backlight, a resin plate having a size of about 2 to 100 inches diagonal and a thickness of 1 to 4 mm and including a diffusible filler, or an optical plate provided with a shape having a diffusion function or a layer containing a filler on a glass surface can be used. In the case of a side light-type backlight, a transparent resin plate having a size of one inch to several tens of inches diagonal and a thickness of about 0.5 to 10 mm, a resin plate including a filler, a resin plate provided with a shape on the surface thereof, or a resin plate including a filler and provided with a shape on the surface thereof can be used.

In consideration of the fact that, when a liquid crystal display is stored in a high-temperature environment at 40° C., the temperature in the device increases to about 60° C. during lighting of the liquid crystal display, and the fact that an actual liquid crystal television or the like is provided with a temperature elevation prevention function in order to avoid degradation of a polarizer at 70° C., preferably, the change in rigidity of the support 23 is small up to 70° C. and the support 23 has a certain degree of elasticity. Examples of the material for the support 23 having such characteristics include materials containing, as major components, polycarbonate (elastic modulus 2.1 GPa), polystyrene (elastic modulus 2.8 GPa), a Zeonor resin (elastic modulus 2.1 GPa) as a cycio-olefin resin, an acrylic resin (elastic modulus 3 GPa), and the like. It is preferable that a material having an elastic modulus higher than or equal to the elastic modulus (2.1 GPa or more) of the polycarbonate resin, which has the lowest, elastic modulus among the above-described materials, be contained as a major component.

Preferably, the support 23 is composed of, for example, a polymer material, and the transmittance thereof is 30% or more. The order of stacking of the optical element 24 and the support 23 is selected in accordance with, for example, the functions provided to the optical element 24 and the support 23. For example, in the case where the support 23 is a diffusion plate, the support 23 is disposed on the light incident side of the illuminating device 1. In the case where the support 23 is a reflective polarizer, the support. 23 is disposed on the side from which light is emitted toward the liquid crystal panel 3. Furthermore, a structure in which an optical functional layer having a light splitting or diffusing function is provided on the light source side of a transparent plate or diffuser plate serving as the support 23 may be combined. A light diffusion functional layer may be further provided on the light-emitting side of the transparent plate or the diffuser plate, or a light condensation functional layer may be used in combination. The shapes of the light-incident surface and the light-emitting surface of the optical element 24 and the support 23 are selected in accordance with the shape of the liquid crystal panel 3, and are, for example, rectangular shapes having different aspect ratios.

Preferably, the principal surfaces of the optical element 24 and the support 23 are subjected to roughening treatment or are allowed to contain fine particles. The reason for this is that rubbing off and friction can be reduced. Furthermore, as necessary, by incorporating additives, such as a light stabilizer, an ultraviolet absorber, an antistatic agent, a flame retardant, and an antioxidant, into the optical element 24 and the support 23, an ultraviolet, absorption function, an infrared absorption function, an antistatic function, and the like may be provided to the optical element 24 and the support 23. Furthermore, diffusion of reflected light or reflected light itself may be reduced by subjecting the optical element 24 and the support 23 to surface treatment, such as anti-reflection treatment (AR treatment) or anti-glare treatment (AG treatment). The surfaces of the optical element 24 and the support 23 may be provided with a function of reflecting ultraviolet rays or infrared rays.

### (Packaging Member)

Preferably, the packaging member 22 substantially entirely covers the optical element stack 21. The packaging member 22 has one or a plurality of openings. In the case where, for example, the optical element stack 21 is covered with the packaging member 22, air in the packaging member 22 is discharged to outside through such an opening, and the optical element stack 21 and the packaging member 22 can be brought in close contact with each other. Thereby, the occurrence of image defects can be prevented. Furthermore, in the case where constituent materials of the support 23 and the optical element 24 covered with the packaging member 22 volatilize, the volatilized components are discharged to outside of the optical package 2 through such an opening, and condensation, solidification, or the like of the volatilized components in the packaging member 22 can be prevented. Thereby, the occurrence of image defects can be prevented. When a plurality of openings are disposed in the packaging member 22, preferably, an opening is disposed in each of end surfaces opposite to each other or in the vicinity thereof. The reason for this is that the above-described volatilized components are efficiently discharged to outside of the optical package 2, and condensation, solidification, or the like of the volatilized components in the packaging member 22 can be further prevented. Thereby, the occurrence of image defects can be further prevented.

The opening is preferably disposed at a position corresponding to the outside of the display area of the optical element stack 21, and more preferably disposed at a position corresponding to the end face of the optical element stack 21 or in the vicinity thereof. Degradation of image quality due to the opening can be prevented by disposing the opening at such a position. In the case where the optical element stack 21 has a corner portion, preferably, an opening is disposed at the position corresponding to the corner portion of the optical element stack 21 so that the corner portion is exposed at, the opening. Specifically, in the case where the optical element stack 21 has a rectangular shape as a whole, preferably, the packaging member 22 is provided with openings disposed at positions corresponding to four corners of the optical element stack 21 so that the corner portions are exposed at the corresponding openings. Preferably, the size and the shape of the opening are selected in consideration of the air discharge performance in the manufacturing process of the optical package 2, the shape of the optical element stack 21, the durability of the packaging member 22, and the like. Examples of the shape include, but are not limited to, a circular shape, an elliptical shape, a semicircular shape, a triangular shape, a quadrangular shape, a rhombic shape, and a slit-like shape.

The shape of the packaging member 22 is, for example, tubular or bag-like, although not particularly limited thereto. The shape of the packaging member 22 can be selected appropriately according to the desired characteristics and shape of the optical package 2. Furthermore, the packaging member 22 may be provided with one or a plurality of packaging members, and by joining the peripheral portions of the packaging members, as necessary, the packaging member 22 may be formed into a tubular or bag-like shape. When the packaging member 22 is formed by joining, the position of junction is preferably located outside the display area of the optical element stack 21.

The packaging member 22 is composed of, for example, a single-layer or multilayer film or sheet, having transparency. The thickness of the packaging member 22 is, for example, in a range of 5 to 5,000 μn. The first region R₁ and the second region R₂ of the packaging member 22 may have different thicknesses. The thickness of each of the first region R₁ and the second region R₂ can be selected according to the desired purpose. For example, in order to protect the support 23 and the optical element 24 from heat generated by the light, source 11 and to suppress the change in shape of the support 23 and the optical element 24, preferably, the thickness of the first region R₁ is set larger than the thickness of the second region R₂. Furthermore, the packaging member 22 covers 50% or more of the principal surface of the optical element stack 21 in terms of area ratio. Preferably, the screen display region is covered, or one or both of the principal surfaces in the screen display region are opened. Furthermore, the packaging member 22 may include a structure serving as a frame. The packaging member 22 has, for example, uniaxial anisotropy or biaxial anisotropy. For example, in the ease where the packaging member 22 has a rectangular shape, the packaging member 22 has uniaxial anisotropy of the positive or negative refractive index characteristic in a longitudinal direction of the packaging member 22 or biaxial anisotropy of the positive or negative refractive index characteristic in a longitudinal direction of the packaging member 22.

In the case where the packaging member 22 has anisotropy, preferably, the optical anisotropy thereof is low. Specifically, the retardation thereof is preferably 50 nm or less. Alternatively, in the case where the optical axis of the optical anisotropy follows the longitudinal or short axis of the included member, the retardation is not limited to 50 nm or less as long as, for example, color characteristics due to viewing angle satisfy the intended application. Furthermore, the packaging member 22 can be used without limiting the anisotropy of the packaging member 22 by providing a diffusion function on the light-emitting side of the packaging member 22, by designing the packaging member 22 so as to have a function of diffusing the light which has passed through the principal surface of the first region R₁, or by providing an optical function, such as a diffusing function, on the light-emitting side of the optical package 2.

The packaging member 22 preferably has a shrinkage property or a stretching property. The reason for this is that the optical element stack 21 and the packaging member 22 can be brought into close contact with each other. The packaging member 22 preferably has at least one of a heat shrinkage property and an energy ray irradiation shrinkage property as the shrinkage property. The reason for this is that the packaging member 22 can shrink easily only due to application of heat or energy ray irradiation m the manufacturing process. It is preferable to use a monoaxially stretched or sequentially or simultaneously biaxially stretched sheet or film as the packaging member 22. In the case where such a sheet or film is used, since the packaging member 22 can shrink in the direction of stretching, for example, by application of heat, adhesion between the packaging member 22 and the optical element stack 21 can be enhanced. Furthermore, extensible films or sheets may be used as the packaging member 22. After such films or sheets are extended mainly in a desired direction of covering by stretching, the inclusion is sandwiched by the extensible films or sheets, peripheries surrounding the inclusion are joined by bonding or welding, and then the tension of the extensible films or sheets is relieved. Thereby, adhesion with the included support and/or the optical element can be enhanced. Furthermore, as the packaging member 22, preferably, a film or sheet exhibiting an energy ray irradiation shrinkage property is used. The reason for this is that adhesion between the packaging member 22 and the optical element stack 21 can be enhanced. Here, examples of the film or sheet exhibiting the energy ray irradiation shrinkage property include polymer materials having a property of being caused to shrink by irradiation of infrared rays. In such a manner, the packaging member 22 includes the support 23 and/or the optical element 24 under shrinkage force, and tensile stress (i.e., tension) can be exerted in the in-plane direction of the packaging member 22,

As the material for the packaging member 22, preferably, a beat shrinkable polymer material is used, and more preferably, a polymer material that shrinks due to application of heat from room temperature to 85° C. is used. Examples of the heat shrinkable polymer material include polyolefin resins, such as polyethylene (PE) and polypropylene (PP); polyester resins, such as polyethylene terephthalate (PET) and polyethylene naphthalate (PEN); vinyl bond systems, such as polystyrene (PS) and polyvinyl alcohol (PVA); polycarbonate (PC) resins; cyclo-olefin resins; methane resins; vinyl chloride resins; natural rubber resins; and artificial rubber resins. These can be used alone or in combination of two or more.

The heat shrinkage of the packaging member 22 is preferably 0.2% or more, more preferably 5% or more, still more preferably 10% or more, and most preferably 20% or more. The reason for this is that adhesion between the packaging member 22 and the optical element stack 21 can be enhanced by setting the heat shrinkage within the range described above. The heat distortion temperature of the packaging member 22 is preferably 80° C. or higher, and more preferably 90° C. or higher. The reason for this is that degradation of the optical properties of the optical package 2 due to the heat generated from the light source 11 can be suppressed. Preferably, the loss on drying of the material for the packaging member 22 is 2% or less. The refractive index of the material for the packaging member 22 (refractive index of the packaging member 22) is preferably 1.6 or less, and more preferably 1.55 or less for the purpose of reducing the interface reflection loss in order to increase the light transmittance, and is preferably 1.45 or more, and more preferably 1.5 or more in the case where optical function factors, such as a light-condensing effect and a light-splitting effect, are added.

Preferably, the packaging member 22 contains one type or two or more types of filler for the purpose of improving scratch resistance of the surface, prevention of adhesion to the liquid crystal panel 3 of the liquid crystal display, prevention of sticking to the included optical element 24 and support 23, or prevention of abrasion caused by pins (studs) for regulating the gap between the direct-type light source 11 and the optical element 24 because of vibration during transportation and the like.

The packaging member 22 has a first region R₁ through which light entering the support 23 is transmitted, and a second region R₂ through which tight emitted from the support 23 is transmitted. At least one of the first region R₁ and the second region R₂ contains voids and a filler disposed in the voids. By employing such a structure, it is possible to provide a diffusion function to at least one of the first region R₁ and the second region R₂.

The voids and the filler are included, for example, in the entire packaging member 22 or in a region in the vicinity of at least one surface of the packaging member 22. Preferably, the voids and the filler are included in at least one of the entire first region R₁ and the entire second region R₂, and more preferably, the voids and the filler are substantially uniformly dispersed in the vicinity of the entire surface of at least one of the first region R₁ and the second region R₂.

For example, at least one type of filler selected from organic type and inorganic type can be used as the filler. As the material for the organic filler, for example, one or two or more materials selected from the group consisting of acrylic resins, stymie resins, fluorine, and cavities can be used. As the inorganic filler, for example, one type or two or more types selected from the group consisting of silica, alumina, talc, titanium oxide, and barium sulfate can be used. These organic and inorganic fillers can be used alone or both types can be used. Regarding the shape of the filler, various shapes, such as a needle-like shape, a spherical shape, an ellipsoidal shape, a tabular shape, and a scale-like shape, can be employed. The filler may have one or two or more kinds of diameters. More preferably, the filler is composed of hollow particles. The reason for this is that a difference in the refractive index leads to improvement in diffusing properties.

Furthermore, for the same purpose as that of inclusion of the filler into the packaging member 22, a shape may be provided to the surface of the packaging member 22. For example, it is possible to provide a shape to one surface or both surfaces of the packaging member 22 composed of a thermoplastic resin by an operation of thermal laminating, embossing, or the like. A heat-shrinkable film may be obtained by carrying out stretching/heat-setting after the shape is provided. Alternatively, a heat-shrinkable film may be provided with a shape by an operation of thermal laminating, embossing, or the like to obtain a film.

When a shape is provided by thermoforming/mechanical embossing, film inclusion molding, use of an energy-curable resin, or the like, it is possible to provide a light controlling function, such as light condensation, light diffusion, or light splitting, on one or both principal surfaces on the light-incident side and the light-emitting side.

For example, by providing a lens shape on the light-emitting side of the packaging member 22, an effect of improving luminance can be obtained. Similarly, by providing a shape a having diffusion function, an effect of eliminating non-uniformity of the light source can be obtained, and by providing a microlens shape, a light-condensing function can be obtained. Furthermore, by providing a lens shape or a diffusion function to the light-source side of the packaging member 22, it is also possible to obtain an effect of reducing non-uniformity of the light source.

In the case where an optical function is provided on the packaging member 22, the optical function can be provided on at least one of the principal surface on the light incident side and the principal surface on the light-emitting side depending on the purpose of the optical function. The optical function provided on the one principal surface may be different from the optical function provided on the other principal surface, namely, different optical functions may be provided. For example, optical functions, such as transparency, light condensation, light diffusion, and light splitting, may be used alone or in combination. The optical functions to be provided may be the same as the included optical functions, and may be selected depending on the intended use.

As necessary, additives, such as a light stabilizer, an ultraviolet absorber, an antistatic agent, a flame retardant, and an antioxidant may be further incorporated into the packaging member 22, and thereby an ultraviolet absorption function, an infrared absorption function, an antistatic function, and the like may be provided to the packaging member 22. Furthermore, diffusion of reflection light or reflection light itself may be reduced by subjecting the packaging member 22 to a surface treatment, such as an anti-glare treatment (AG treatment) or an anti-reflection treatment (AR treatment). Moreover, a function of transmitting light in a specific wavelength region, e.g., UV-A light (about 315 to 400 nm), may be provided.

An irregular structure serving as an optical function may be provided on the surface of the packaging member 22. Furthermore, in order to prevent sticking and improve scratch resistance, a structure with waviness may be employed. By adding waviness, for example, to lenses which serve as a light-condensing function and are arranged in parallel, in the ridge direction, contact with the tops of the lenses can be prevented. In addition to the one surface, an optical function or a structure for preventing sticking or resisting scratch may be provided on the back surface.

### (Liquid Crystal Panel)

The liquid crystal panel 3 modulates light supplied from the light source 11 in terms of time and space so as to display information. As the operational mode of the liquid crystal panel 3, for example, a twisted nematic (TN) mode, a vertically aligned (VA) mode, an in-plane switching (IPS) mode, or an optically compensated birefringence (OCB) mode is employed.

### (1-2) Structure of Optical Package

### (1-2-1) FIRST EXAMPLE OF STRUCTURE

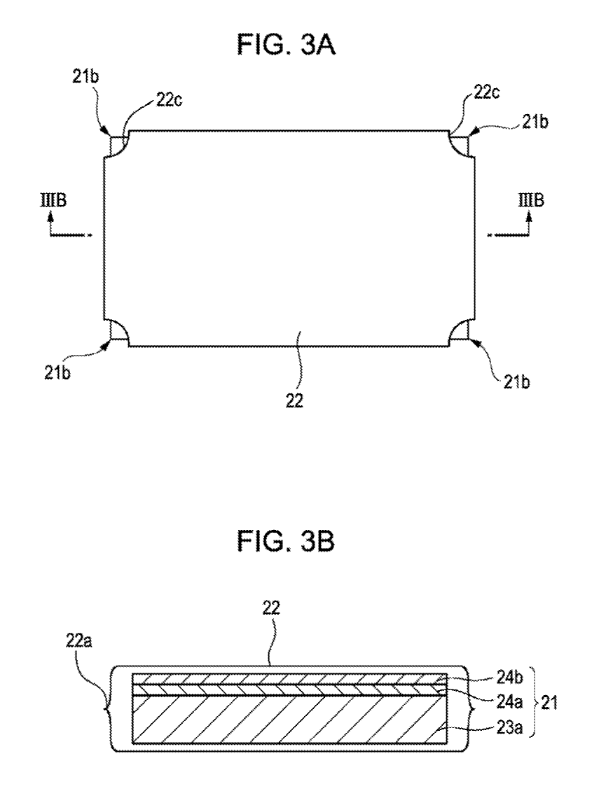

A first, example of a structure of the optical package 2 according to the first embodiment will now be described in detail with reference to FIGS. 2 to 5. FIGS. 2, 3A, and 3B show the first example of the structure of the optical package according to the first embodiment. As shown in FIGS. 2, 3A, and 3B, the optical package 2 includes, for example, a diffuser plate 23a, which is a plate-like support, a diffuser film 24a and a prism sheet 24b, which are film-like or sheet-like optical elements, and a packaging member 22 which covers and integrates the support and the optical elements. The packaging member 22 has a film-like or sheet-like shape. The packaging member 22 has a shrinkage property or a stretching property and contains voids and a filler disposed in the voids. In this example, the diffuser plate 23a, the diffuser film 24a, and the prism sheet 24b constitute an optical element stack 21. The diffuser film 24a and the prism sheet 24b are disposed on the light-emitting surface side of the diffuser plate 23a. Specifically, the diffuser film 24a and the prism sheet 24b are disposed in that order from the light-emitting surface side of the diffuser plate 23a toward the light-incident surface side of the packaging member 22.

As shown in FIG. 2, the packaging member 22 includes a first packaging member 22₁ which covers the light-incident surface of the optical element stack 21, and a second packaging member 22₂ which covers the light-emitting surface. The -first packaging member 22₁ and the second packaging member 22₂ are joined together, for example, by an end face of the optical element stack 21. The shape of each of the first packaging member 22₁ and the second packaging member 22₂ is appropriately selected depending on the shape of the optical element stack 21 to be covered.

The packaging member 22 substantially entirely covers the optical element stack 21. Specifically, the optical element stack 21 has a light-incident surface on which light from the light source is incident, a light-emitting surface from which the light incident on the light-incident surface is emitted, and end faces located between the light-incident surface and the light-emitting surface. The packaging member 22 covers the light-emitting surface, the light-incident surface, and all the end faces of the optical element stack 21. The packaging member 22 has openings 22c in the periphery thereof, and the periphery of the optical element stack 21 is exposed at the openings 22c. Specifically, the packaging member 22 has openings 22c at positions corresponding to corner portions 21b of the rectangular optical element stack 2.1, and the corner portions 21b are exposed at the corresponding openings 22c.

The diffuser plate 23a is placed above one or a plurality of light sources 1 and diffuses light emitted from the one or the plurality of light sources 11 and reflected light from the reflector 12, thereby achieving uniform luminance. As the diffuser plate 23a, for example, a diffuser plate having an irregular structure for diffusing light on the surface thereof, a diffuser plate containing fine particles or the like having a refractive index different from that of the main constituent material of the diffuser plate 23a, a diffuser plate containing hollow fine particles, or a diffuser plate including a combination of two or more selected from the irregular structure, fine particles, and hollow fine particles can be used. As the fine particles, for example, at least one of an organic filler and an inorganic filler can be used. The irregular structure, fine particles, and hollow fine particles are provided, for example, on the light-emitting surface of the diffuser film 24a. The light, transmittance of the diffuser plate 23a is, for example, 30% or more.

The diffuser film 24a is placed on the diffuser plate 23a and diffuses light diffused by the diffuser plate 23a. As the diffuser film 24a, for example, a diffuser film having an irregular structure for diffusing light on the surface thereof, a diffuser plate containing fine particles or the like having a refractive index different from that of the main constituent material of the diffuser film 24a, a diffuser film containing hollow line particles, or a diffuser film including a combination of two or more selected from the irregular structure, fine particles, and hollow fine particles can be used. As the fine particles, for example, at least one of an organic filler and an inorganic filler can be used. The irregular structure, fine particles, and hollow fine particles are provided, for example, on the light-emitting surface of the diffuser film 24a.

The prism sheet 24b is placed above the diffuser film 24a and improves the directivity, etc. of the illumination light. For example, fine lens prism columns are disposed on the light-emitting surface of the prism sheet 24b. Preferably, the cross-section in the column direction, of the prism lens has, for example, a substantially triangular shape, and the vertex thereof is rounded. The reason for tins is that the cutoff can be improved and the wide viewing angle can be improved.

Each of the diffuser film 24a and the prism sheet 24b is composed of, for example, a polymer material, and the retractive index thereof is, for example, preferably 1.45 or more, more preferably 1.5 or more, and most preferably 1.6 or more. Preferably, the material constituting the optical element 24 or the optical functional layer disposed thereon is, for example, an ionic photosensitive resin which is cured by light or electron beams, a thermosetting resin which is cured by heat, or an ultraviolet curable resin which is cured by ultraviolet rays. The material may be prepared from a thermoplastic polymer material.

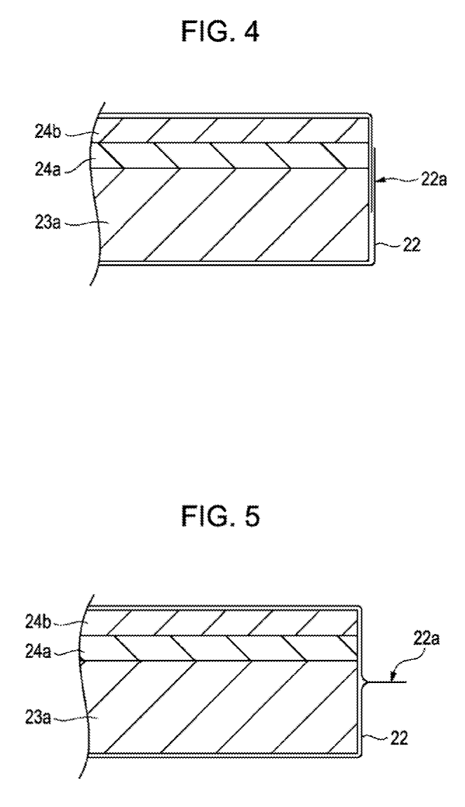

Examples of a junction portion of the packaging member 22 will be described with reference to FIGS. 4 and 5. FIG. 4 shows a first example of a junction portion of the packaging member. In the first example, as shown in FIG. 4, the inner surface of an end portion of the packaging member 22 and the outer surface of another end of the packaging member 22 are joined together so as to overlap each other at the end face of the optical element stack 21. That is, the ends of the packaging member 22 are joined together along the end face of the optical element stack 21. Reference numeral 22a represents a junction portion.

FIG. 5 shows a second example of the junction portion of the packaging member. In the second example, as shown in FIG. 5, inner surfaces of end portions of the packaging member 22 are joined together so as to overlap each other at the end face of the optical element stack 21. That is, the end portions of the packaging member 22 are joined together so as to rise from the end face of the optical element stack 21.

### (1-2-2) SECOND EXAMPLE OF STRUCTURE

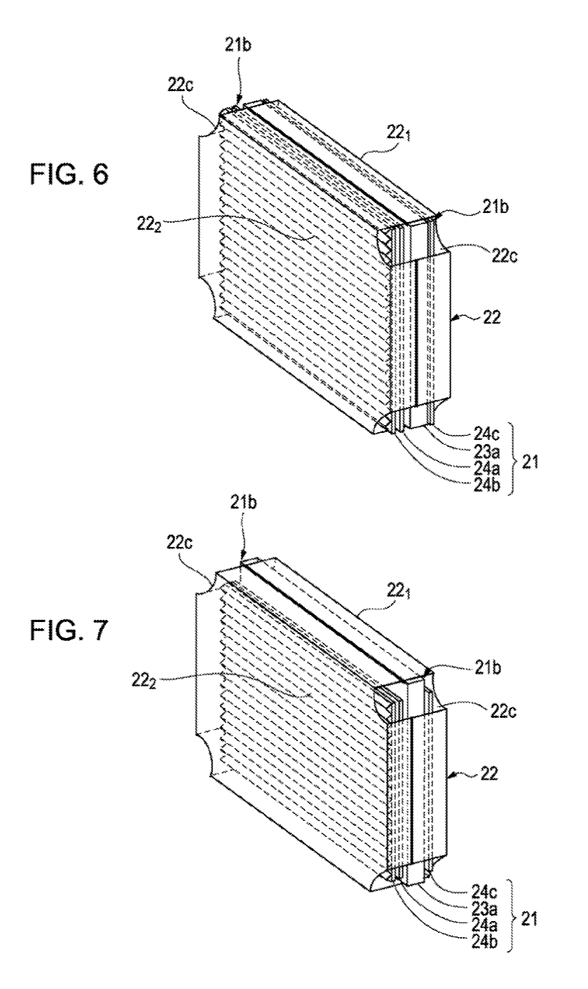

FIG. 6 shows a second example of the structure of the optical package according to the first embodiment. The second example of the structure of the optical package differs from the first example of the structure in that a light control film 24c is disposed between the light-incident surface of the diffuser plate 23a and the light-emitting surface of the packaging member 22. The light control, film 24c is a thin optical sheet in which a plurality of columnar prisms extending along a plane parallel to the bottom surface are arranged side by side continuously on the upper surface thereof. In the case where a plurality of linear light sources are arranged in parallel directly below the optical element stack 21, the individual prisms are preferably arranged in parallel such that the extending direction of the individual prisms are in parallel to the extending direction of the linear light sources (e.g., horizontal direction). However, the individual prisms may be arranged such that the extending direction of the individual prisms intersects the extending direction of the individual linear light sources within an optically acceptable range.

Consequently, the light control film 24c refracts and transmits, for example, the light incident at an angle less than a critical angle on the bottom surface or an upper surface of each prism, among the light emitted from one linear light source, and totally reflects the light incident at an angle more than or equal to the critical angle. Therefore, a function of splitting a light source image produced by one linear light source into a plurality of images in accordance with the number of faces constituting the upper surface of each prism (strictly, the number of faces classified on an angle of inclination basis) is provided. That is, the light control film 24c splits the light source image produced by one linear light source into a plurality of light source images and makes the distance between the light source images formed from the individual light source images after splitting narrower than the distance between the linear light sources. Therefore, the difference between the luminance level of the light source image after splitting (maximum value) and the luminance level in between the light source images after splitting (minimum value) is made smaller than the difference between the luminance level of the light source image before splitting (maximum value) and the luminance level in between the light source images before splitting (minimum value), so that non-uniformity in illumination luminance can be reduced.

The light source image represents a light flux indicating the peak of luminance in the luminance distribution of the light. The distance between the light source images refers to the distance in the in-plane direction between adjacent peaks (tops) in the luminance distribution.

The light control film 24c may be formed integrally using a light-transmissive resin material, such as a thermoplastic resin, or may be formed by transferring an energy ray-curable resin (e.g., ultraviolet-curable resin) on a light-transmissive base material, such as polyethylene terephfhalate (PET).

As the thermoplastic resin, it is preferable to use a thermoplastic resin having a refractive index of 1.4 or more in view of the function of controlling the direction of light emission. Examples of such a resin include polycarbonate resins, acrylic resins such as polymethyl methacrylate (PMMA) resins, polyester resins such as polyethylene terephthalate, amorphous copolymer polyester resins such as MS (copolymer of methyl methacrylate and styrene), polystyrene resins, and polyvinyl chloride resins.

Except for those described above, the second example of the structure is the same as the first example of the structure.

### (1-2-3) THIRD EXAMPLE OF STRUCTURE

FIG. 7 shows a third example of the structure of the optical package according to the first embodiment. The third example of the structure of the optical package differs from the second example of the structure in that each of the diffuser film 24a, the prism sheet 24b, and light control film 24c, which are optical elements, has a smaller size than the diffuser plate 23a which is a support. In such a structure, the tension of the packaging member 22 can be applied mainly to the diffuser plate 23a. Therefore, it is possible to prevent the occurrence of wrinkles, etc. in the diffuser film 24a, the prism sheet 24b, and the light control film 24c.

Except for those described above, the third example of the structure is the same as the first example of the structure.

### (1-3) Structure of Packaging Member

### (1-3-1) FIRST EXAMPLE OF STRUCTURE

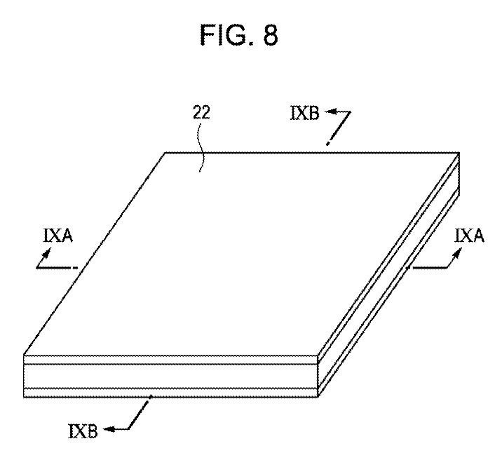

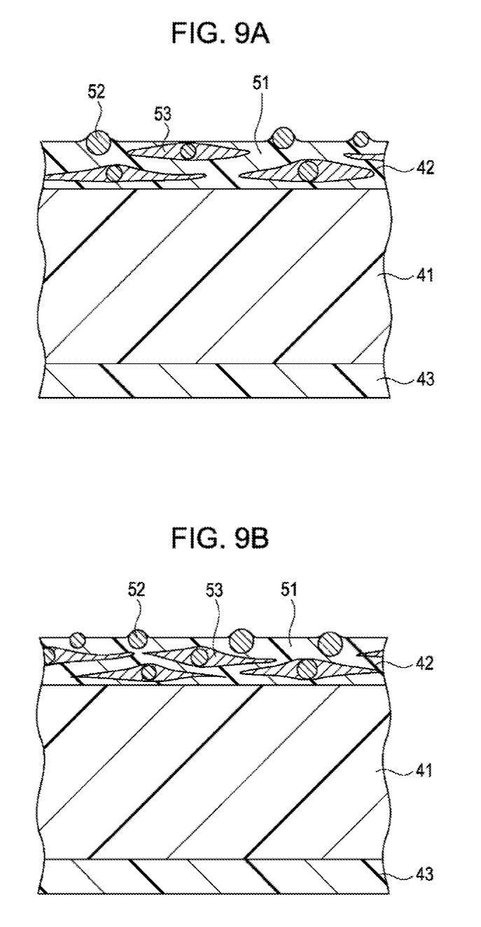

FIG. 8 is an enlarged view showing part of a packaging member. FIG. 9A is a schematic cross-sectional view showing the packaging member shown in FIG. 8, taken along the line IXA-IXA of FIG. 8, and FIG. 9B is a schematic cross-sectional view showing the packaging member shown in FIG. 8, taken along the line IXB-IXB of FIG. 8. A packaging member 22 includes a base material layer 41, a first surface layer 42 disposed on one principal surface of the base material layer 41, and a second surface layer 43 disposed on the other principal surface of the base material layer 41. The first surface layer 42 includes a binder 51, voids 53, and a filler 52 disposed in the voids 53. Consequently, the packaging member 22 has diffusing properties. The filler 52 protrudes from the surface of the first surface layer 42. Examples of the shape of the voids 53 include a disc-like shape, an ellipsoidal shape, and a cubic shape, although not particularly limited thereto. The shape of the voids 53 can be arbitrarily selected depending on the desired diffusion function. Furthermore, the shape and the size of the voids 53 may be controlled according to the viewing angle, etc. of the liquid crystal panel 3. Preferably, the first surface layer is disposed so as to be an outer surface of the optical package 2. The reason for this is that the light-diffusing function can be improved.

As the material for each of the first surface layer 42 and the second surface layer 43, preferably, a material having higher heat resistance than the base material layer 41 is used. As the material for each of the base material layer 41, the first surface layer 42, and the second surface layer 43, preferably, a polymer material having a heat shrinkage property can be used, and more preferably, a polymer material that shrinks due to application of heat from room temperature to 85° C. can be used. Examples of the heat shrinkable polymer material include polyolefin resins, such as polyethylene (PE) and polypropylene (PP); polyester resins, such as polyethylene terephthalate (PET) and polyethylene naphthalate (PEN); vinyl, bond systems, such as polystyrene (PS) and polyvinyl alcohol (PVA); polycarbonate (PC) resins; cyclo-olefin resins; urethane resins; vinyl chloride resins; natural rubber resins; and artificial rubber resins. These can be used alone or in combination of two or more.

### (1-3-2) SECOND EXAMPLE OF STRUCTURE

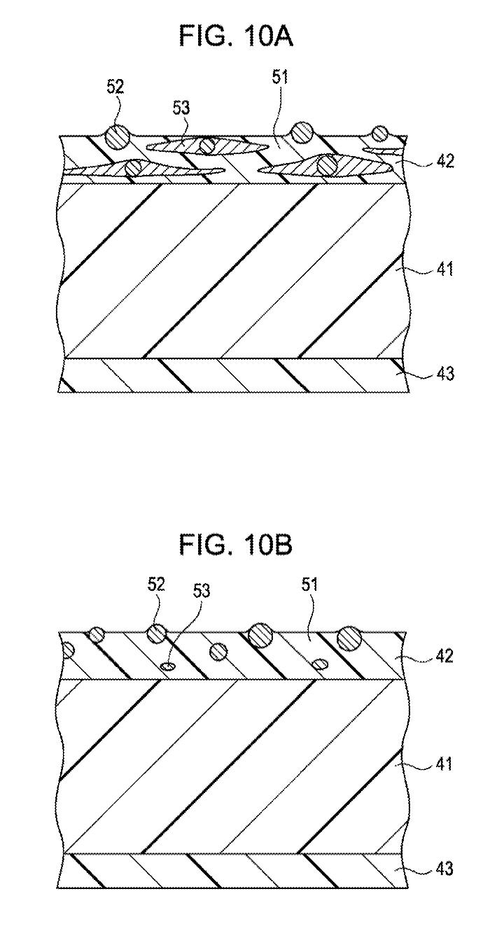

FIG. 10A is a schematic cross-sectional view showing a second example of the structure of the packaging member according to the first embodiment, taken along the line IXA-IXA of FIG. 8, and FIG. 10B is a schematic cross-sectional view showing the second example of the structure of the packaging member, taken along the line IXB-IXB of FIG. 8. The second example of the structure of the packaging member differs from the first example of the structure in that voids 53 having a shape that is long in the direction parallel to the line IXA-IXA of FIG. 8 are formed.

When the direction in which a void 53 is elongated is considered as the longitudinal direction, preferably, the longitudinal directions of the voids 53 are aligned in the same direction (the direction parallel to the line IXA-IXA of FIG. 8 in this case). Furthermore, an arrangement may be made such that the longitudinal direction of the voids 53 is aligned with the horizontal direction or the perpendicular direction of the liquid crystal display.

Except, for those described above, the second example of the structure is the same as the first example of the structure.

### (1-3-3) THIRD EXAMPLE OF STRUCTURE

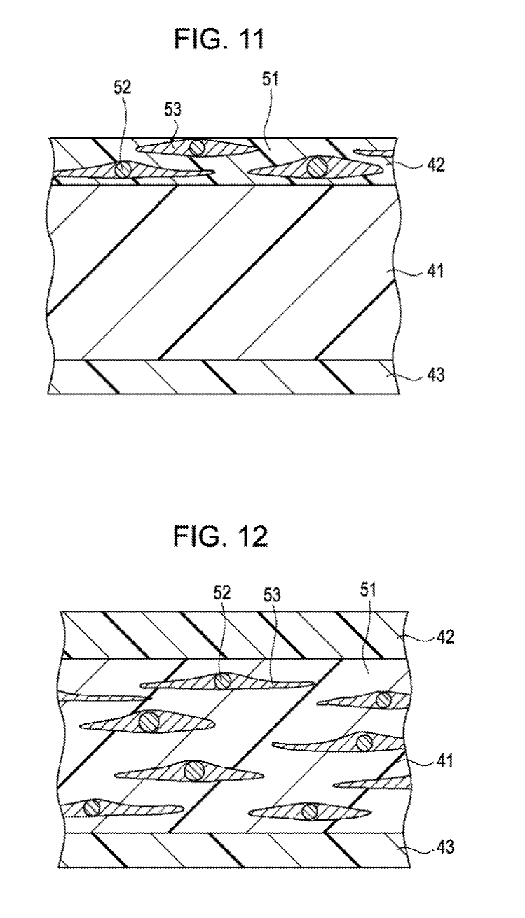

FIG. 11 shows a third example of the structure of the packaging member according to the first embodiment. The third example of the structure of the packaging member differs from the first example of the structure in that the filler 52 does not protrude from the surface of the first surface layer 42. That is, irregularities are not formed on the surface of the packaging member 22.

Except for those described above, the third example of the structure is the same as the first example of the structure.

### (1-3-4) FOURTH EXAMPLE OF STRUCTURE

FIG. 12 shows a fourth example of the structure of the packaging member according to the first embodiment. The fourth example of the structure of the packaging member differs from the first example of the structure in that the first surface layer 42 does not include voids or a filler, and the base material layer 41 includes voids 53 and a filler 52 disposed in the voids 53.

Except for those described above, the fourth example of the structure is the same as the first example of the structure.

### (1-3-5) FIFTH EXAMPLE OF STRUCTURE

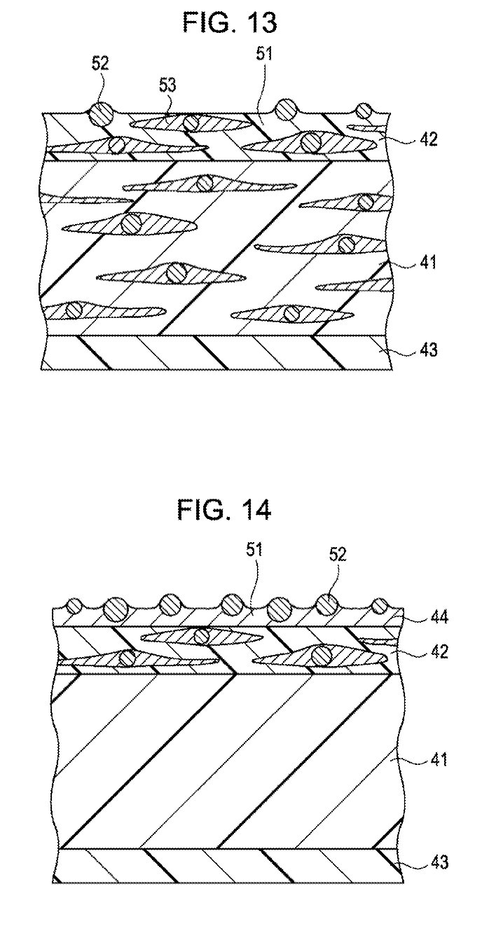

FIG. 13 shows a fifth example of the structure of the packaging member according to the first embodiment. The fifth example of the structure of the packaging member differs from the first example of the structure in that the base material layer 41 includes the voids 53 and the filler 52 disposed in the voids 53.

Except for those described above, the fifth example of the structure is the same as the first example of the structure,

### (1-3-6) SIXTH EXAMPLE OF STRUCTURE

FIG. 14 shows a sixth example of the structure of the packaging member according to the first embodiment. The sixth example of the structure of the packaging member differs from the first example of the structure in that an irregular layer 44 is disposed on the surface of the first surface layer 42 which includes the voids and the filler 52 disposed in the voids 53.

The irregular layer 44 includes the binder 51 and the filler 52. The filler 52 protrudes from the surface of the irregular layer 44.

Except for those described above, the sixth example of the structure is the same as the first example of the structure.

### (1-3-7) SEVENTH EXAMPLE OF STRUCTURE

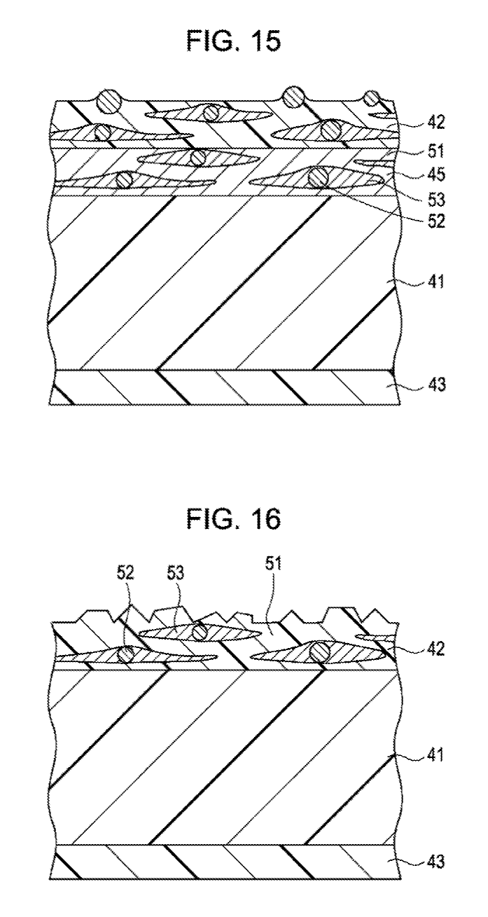

FIG. 15 shows a seventh example of the structure of the packaging member according to the first embodiment. The seventh example of the structure of the packaging member differs from the first example of the structure in that a diffusion layer 45 is disposed between the base material layer 41 and the first surface layer 42.

The diffusion layer 45 includes the binder 51, the voids 53, and the filler 52 disposed in the voids 53.

Except for those described above, the seventh example of the structure is the same as the first example of the structure.

### (1-3-8) EIGHTH EXAMPLE OF STRUCTURE

FIG. 16 shows an eighth example of the structure of the packaging member according to the first embodiment. The eighth example of the structure of the packaging member differs from the first example of the structure in that an irregular shape is formed on the surface of the first surface layer 42 for the same purpose as that of protruding the filler 52 from the surface of the first surface layer 42 in the first example of the structure. The irregular shape on the surface of the first surface layer 42 can be formed, for example, by thermal lamination or embossing.

Except, for those described above, the eighth example of the structure is the same as the first example of the structure.

### (1-3-9) NINTH EXAMPLE OF STRUCTURE

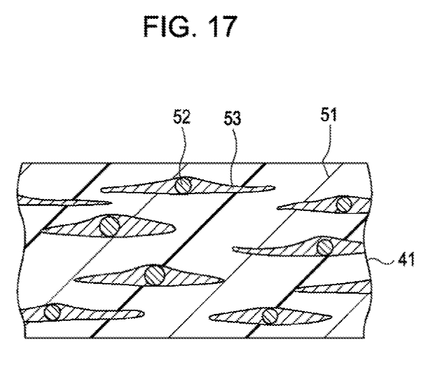

FIG. 17 shows a ninth example of the structure of the packaging member according to the first embodiment. The ninth example of the structure of the packaging member differs from the first example of the structure in that, the package member includes only the base material layer 41 including the voids 53 and the filler 52 disposed in the voids 53.

Except for those described above, the ninth example of the structure is the same as the first example of the structure. The filler 52 may protrude from the surface of the base material layer 41, or an irregular shape may be formed by embossing or the like on the surface of the base material layer 41.

### (1-3-10) TENTH EXAMPLE OF STRUCTURE

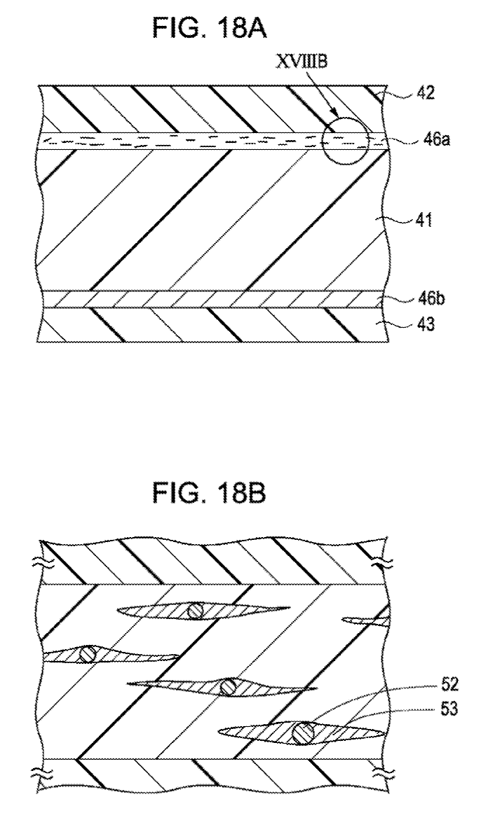

FIG. 18A shows a tenth example of the structure of the packaging member according to the first embodiment. The tenth example of the structure of the packaging member includes a base material layer 41, a first surface layer 42 disposed on one principal surface of the base material layer 41 with an adhesion layer 46a therebetween, and a second surface layer 43 disposed on the other principal surface of the base material layer 41 with an adhesion layer 46b therebetween.

The adhesion layers 46a and 46b bond the base material layer 41 to the first surface layer 42 and the second surface layer 43, respectively.

FIG. 18B is an enlarged view of a region indicated by XVIIIB in FIG. 18A. As shown in FIG. 18B, the adhesion layer 46a includes voids 53, a filler 52 disposed in the voids 53, and an adhesive. Examples of the adhesive include hot-melt adhesives, such as ethylene-vinyl acetate copolymer (EVA)-based, olefin-based, thermoplastic elastomer (TPR)-based (e.g., styrene-isoprene-styrene (SIS) copolymers and styrene-ethylene-butylene-styrene (SEBS) copolymers), polyester-based, and polyamide-based adhesives; thermosetting epoxy adhesives; and energy ray-curable adhesives including photocurable (UV adhesion) resins and electron beam-curable resins.

Except, for those described above, the tenth example of the structure is the same as the first example of the structure. In the tenth example of the structure, at least one of the first surface layer 42 and the base material layer 41 may include the voids 53 and the filler 52 disposed in the voids 53.

### (1-4) Method of Manufacturing Optical Package

An example of a method of manufacturing an optical package 2 having the structure described above will now be described.

First, materials for a first surface layer 42, a base material layer 41, and a second surface layer 43, such as those described above, are prepared, and a filler 52 is added to at least one of the materials. Then, using these materials, a laminated film is obtained by coextrusion. Longitudinal stretching is carried out in the machine direction, and as necessary, transverse stretching is carried out. Thereby, a monoaxially stretched, sequentially biaxially stretched sheet, or simultaneously stretched packaging member 22 including a layer or layers including voids 53 and the filler 52 disposed in the voids 53 is obtained. By incorporating the filler as described above and forming the packaging member 22 so as to be integrated with the diffusion function, the voids 53 can be easily formed in the packaging member 22 without increasing the number of processes. The resulting packaging member 22 is cut according to the size of the optical package 2 to be manufactured, and thereby a first packaging member 22₁ and a second packaging member 22₂ are obtained.

Other than the method in which the filler is incorporated into the packaging member 32 as described above, there may be mentioned a method in which, by forming a surface layer of the packaging member 22 using a mixture of a resin and particles, or by applying a coating material composed of a resin, particles, and a solvent to a surface layer of the packaging member 22 and drying the solvent so that a filler is contained, an irregular layer from which the filler protrudes is formed on the surface of the packaging member 22, a method in which film formation and molding are performed using an energy curing system (UV-curing, visible light curing, electron beam curing, or the like) containing a filler, a method in which a filler-containing layer prepared as described above is transferred, or a method in which embossing is performed,

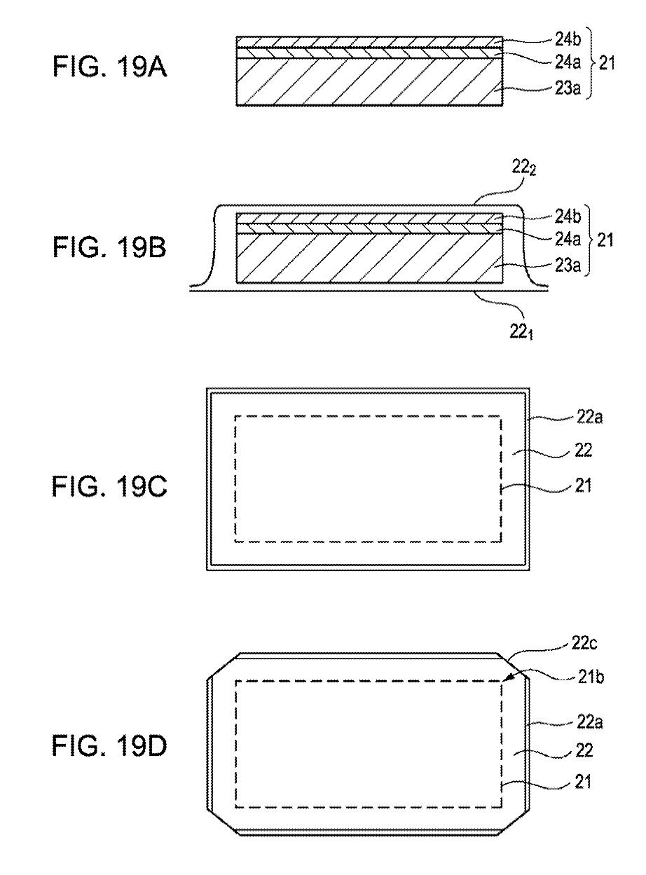

Next, as shown in FIG. 19A, a diffuser film 24a and a prism sheet 24b, which are optical elements, are stacked in that order on a diffuser plate 23a, which is a support, and thereby an optical element stack 21 is obtained. Next, as shown in FIG. 19B, the optical element stack 21 is placed on the first packaging member 22₁, and then the second packaging member 22₂ is placed thereon. Next, as shown in FIG. 19C, peripheries 22a of the first packaging member 22₁ and the second packaging member 22₂ are joined to each other. As the joining method, for example, bonding or welding is used. Examples of the bonding method include a hot melt bonding method, a thermosetting bonding method, a pressure-sensitive (adhesion) bonding method, an energy ray-curing adhesion method, a hydration bonding method, and a hygroscopic/remoistening adhesion method. Examples of the welding method include thermowelding, ultrasonic welding, and laser welding. Thereby, the optical element stack 21 is entirely covered with the packaging member 22. Next, as shown in FIG. 19D, for example, by cutting the packaging member 22 at portions corresponding to corner portions 21b of the optical element stack 21, openings 22c are formed.

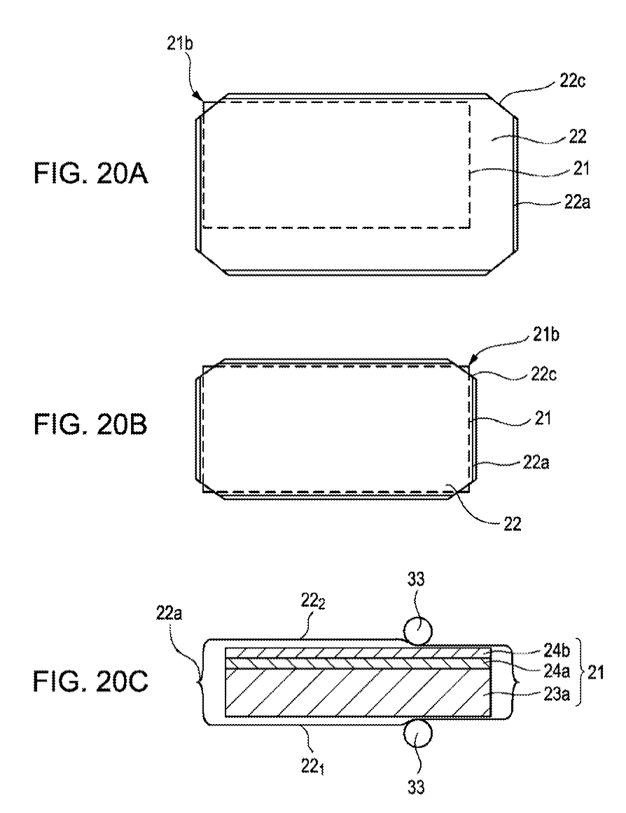

Next, as shown in FIG. 20A, for example, by moving the optical element stack 21 toward one corner, the corner portion 21b is exposed from the opening of the packaging member 22. Next, as shown in FIG. 20B, by subjecting the packaging member 22 to heat treatment, the packaging member 22 is caused to shrink such that the packaging member 22 covers the optical element stack 21 under a shrinkage force. Thereby, at any region of the first packaging member 22₁ and the second packaging member 22₂, tensile stress (i.e., tension) is applied in the in-plane direction of the first packaging member 22₁ and the second packaging member 22₂. Next, as shown in FIG. 20C, as necessary, one principal surface or both surfaces of the optical element stack 21 covered with the packaging member 22 are pressed with a pressure roller 33, and the pressure roller 33 is moved while rotating over one principal surface or both principal surfaces. Thereby, excess air in the packaging member 22 is discharged from the openings 22c, and the packaging member 22 and the optical element stack 21 are brought into close contact with each other. In the case where both principal surfaces of the optical element stack 21 are pressed with the pressure roller 33, it may be possible to press the both principal surfaces of the optical element stack while sandwiching the optical element stack covered with the packaging member 22 using two pressure rollers 33. Thereby, the intended optical package 2 can be obtained.

### (2) Second Embodiment

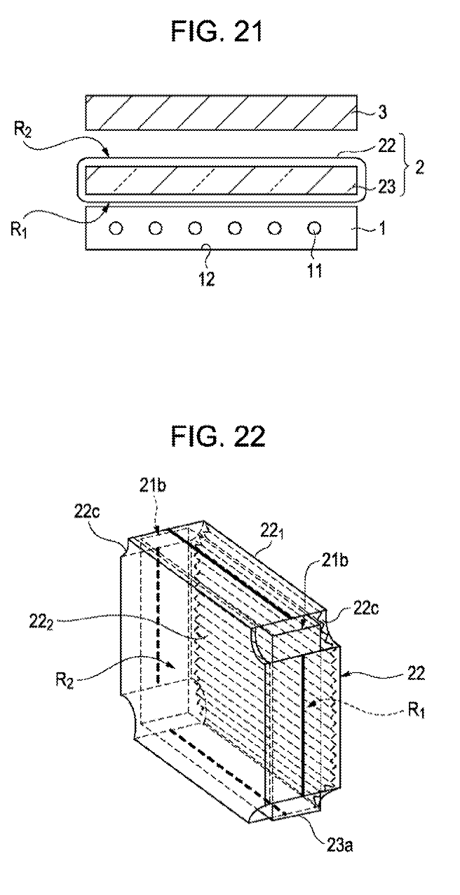

FIG. 21 shows an example of a structure of a liquid crystal display according to a second embodiment. The liquid crystal display differs from the first embodiment in that the packaging member 22 covers only the support 23.

As shown in FIG. 21, the liquid crystal display includes an illuminating device 1 which emits light, an optical package 2 which improves the properties of the light emitted from the illuminating device 1, and a liquid crystal panel 3 which displays an image on the basis of the light, the properties of which have been improved by the optical package 2. The illuminating device 1 and the optical package 2 constitute a backlight. As necessary, optical elements, such as a reflective polarizer and a diffuser film, may be arranged between the optical package 2 and the liquid crystal panel 3.

Furthermore, the optical package 2 includes a plate-like support 23 and a packaging member 22 which covers the support 23. From the standpoint of suppressing degradation of images, preferably, the support 23 and the packaging member 22 are in close contact with each other. Preferably, the support 23 is a plate-like optical element, such as a diffuser plate. The packaging member 22 has a first region R₁ through which light entering the support 23 is transmitted, and a second region R₂ through which light emitted from the support 23 is transmitted. At least one of the first region R₁ and the second region R₂ is provided with an optical function. The optical function is provided, for example, on at least one of the inner surface or the outer surface of the first region R₁ and/or the second region R₂. Examples of the optical functional layer include a light-condensing element, a light diffusion element, a light-controlling element, a polarizer, and a reflective polarizer.

The packaging member 22 substantially entirely covers the plate-like support 23. Specifically, the plate-like support 23 has a light-incident surface on which light from a light source is incident, a light-emitting surface from which the light incident on the light-incident surface is emitted, and end faces located between the light-incident surface and the light-emitting surface, and the packaging member 22 covers the light-emitting surface, the light-incident surface, and all the end faces of the support 23. The packaging member 22 has openings 22c at the periphery thereof and the periphery of the support 23 is exposed at the openings 22c. Specifically, the packaging member 22 is provided with openings 22c disposed at positions corresponding to side portions 21c of the support 23 having a rectangular shape, and the side portions 21c of the support 23 are exposed at the corresponding openings 22c.

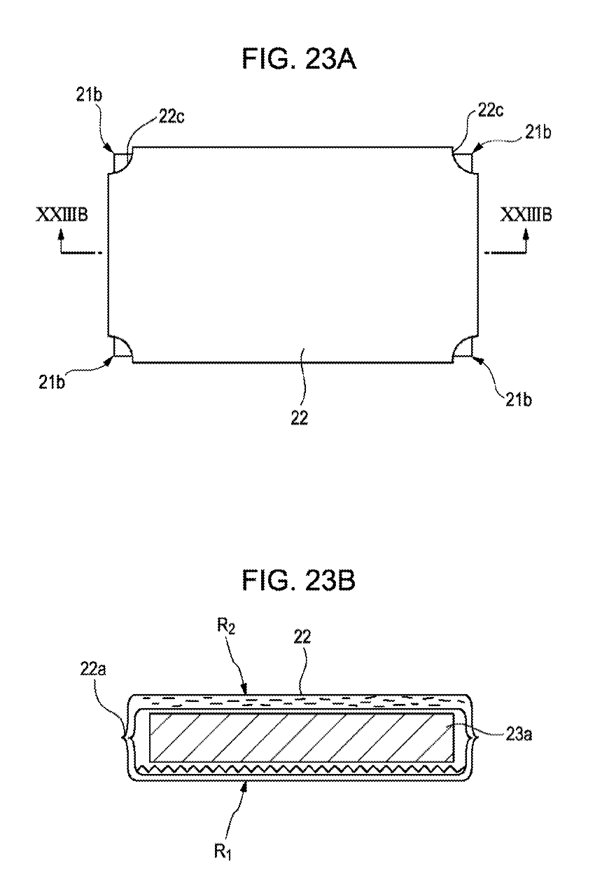

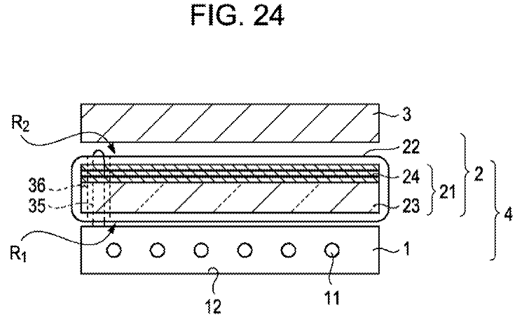

FIGS. 22, 23A, and 23B show an example of a structure of the optical package according to the second embodiment. As shown in FIGS. 22, 23A, and 23B, the optical package 2 includes a diffuser plate 23a, which is a plate-like support, and a film-like or sheet-like packaging member 22 which covers the diffuser plate 23a. The packaging member 22 has a shrinkage property or a stretching property and contains voids and a filler disposed in the voids. The packaging member 22 is provided with a light control function in the first region R₁ through which light incident on the support 23 is transmitted, and a diffusion function in the second region R₂ through which light emitted from the support 23 is transmitted. The light control function corresponds to a function of a light-controlling element, such as a light control film, and the light diffusion function corresponds to a function of a light diffusion element, such as a diffuser film.

Except, for those described above, the second embodiment is the same as the first embodiment.

### (3) Third Embodiment

FIG. 24 shows an example of a structure of a liquid crystal display according to a third embodiment. The liquid crystal display differs from the first embodiment in that the illuminating device 1 includes a supporting portion 35 which supports the optical, package 2, and the optical package 2 includes a portion 36 to be supported which engages with the supporting portion 35 of the illuminating device 1.

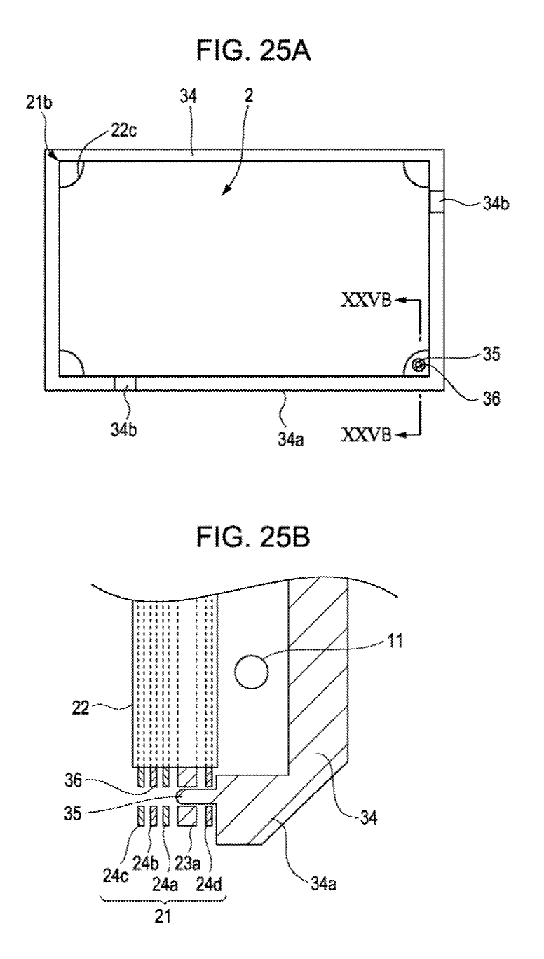

FIGS. 25A and 25B show an example of a structure of a backlight according to the third. The backlight includes one or a plurality of light sources 11, a backlight chassis 34, and an optical package 2 supported by the backlight chassis 34. The optical package 2 includes one or a plurality of portions 36 to be supported. The portion 36 to be supported are preferably disposed in the periphery of the optical package 2, and are preferably disposed at positions exposed at the openings 22c of the packaging member 22. For example, in the case where corner portions 21b of the optical element stack 21 are exposed at the openings 22c of the packaging member 22, preferably, the portion 36 to be supported is disposed on the exposed corner portion 21b. The portion 36 to be supported engages with the supporting portion 35 of the backlight chassis 34 so as to fix the optical package 2 at the predetermined position on the backlight chassis 34. The portion 36 to be supported is, for example, a hole which passes through the optical package 2 in the thickness direction, and a groove formed in the end face of the optical package 2. Examples of the cross-sectional shape of the hole include circular, elliptic, polygonal, and flat shapes, and examples of the cross-sectional shape of the groove include V-like, U-like, L-like, and circular arc shapes. The shapes of the hole and the groove are not limited thereto as long as the supporting portion 35 of the backlight chassis 34 engages with the portion 36 to be supported of the optical package 2 so that the position of the optical package 2 can be fixed.

Furthermore, backlight chassis 34 includes the supporting portion 35 which engage with the portion 36 to be supported of the optical package 2, and one or a plurality of supporting portions 34b which support the end faces of the optical package 2. The supporting portion 35 of the backlight chassis 34 engages with the portion 36 to be supported of the optical package 2 so that the optical package 2 is fixed at the predetermined position on the backlight chassis 34. Examples of the shape of the supporting portion 35 include columnar, rod-like, cylindrical needle-like, arm-like, L-like, T-like, trapezoidal, cone-like, and screw-like shapes. The shape of the supporting portion 35 is not limited thereto as long as the supporting portion engages with the portion 36 to be supported of the backlight chassis 34 so that the position of the optical package 2 can be fixed. The supporting portion 34b supports the end face of the optical element stack 21 so that the optical package 2 can be fixed at the predetermined position, of the backlight chassis 34. The supporting portion 34b is disposed, for example, in the periphery 34a of the backlight chassis. In the case where a plurality of supporting portions 34b are provided, preferably, the supporting portions 34b are disposed at positions that can support the end faces of the optical package 2 in at least two directions. For example, when the optical package 2 has a rectangular shape as a whole, preferably, the supporting portions 34b are disposed at positions that can support two orthogonal sides among the sides of the optical package 2.

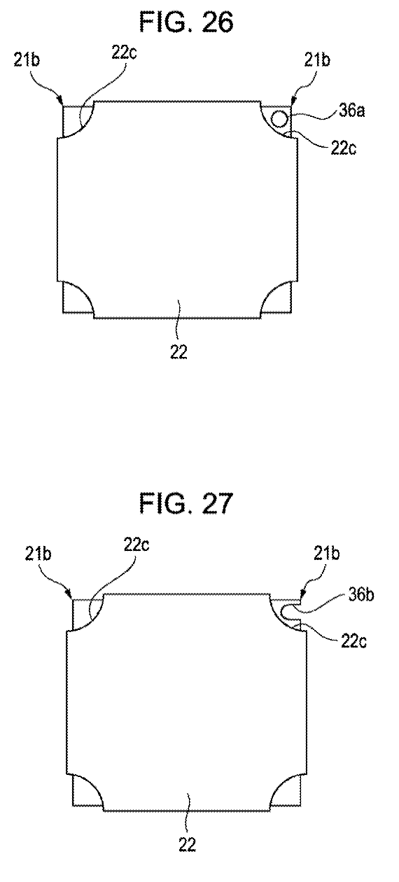

FIG. 26 shows a first example of a structure of the optical package 2. The optical element stack 21, for example, has a rectangular shape as a whole. The packaging member 22 has openings 22c at positions corresponding to corner portions 21b of the optical element stack 21, and the corner portions 21b are exposed at the openings 22c. One of the corner portions 21b exposed at the openings 22c is provided with a hole 36a which engages a columnar supporting portion 35.

FIG. 27 shows a second example of the structure of the optical package 2. One of the corner portions 21b exposed at the openings 22c of the packaging member 22 is provided with a cut out groove 36b having a U-shaped cross section, the groove 36b engaging with a supporting portion 35 having a columnar shape or the like.

Except for those described above, the third embodiment is the same as the first embodiment,

### (4) Fourth Embodiment

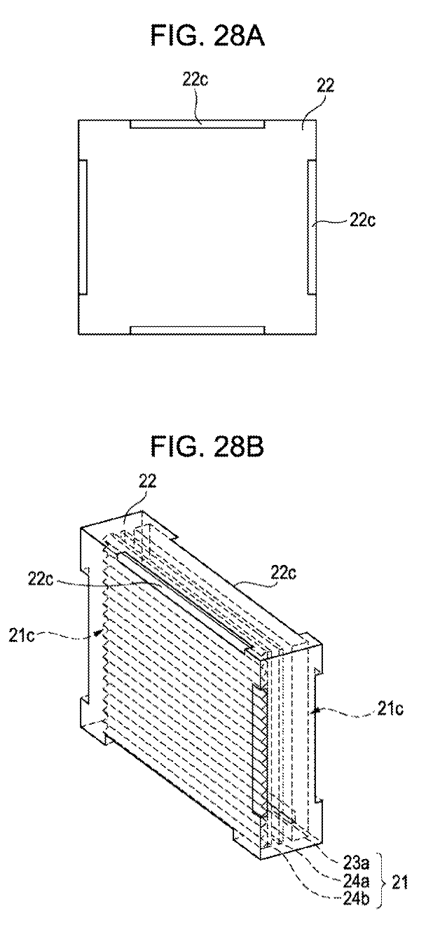

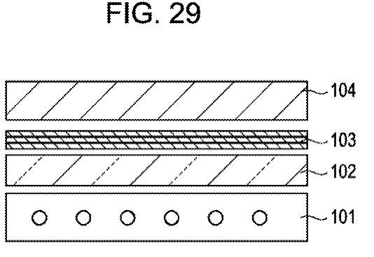

FIGS. 28A and 2813 show an example of a structure of an optical package according to a fourth embodiment. The optical package differs from the first embodiment in that the packaging member 22 has openings 22c at positions corresponding to side portions 21c of the optical element stack 21. As shown in FIGS. 28A and 28B, in the case where the optical element stack 21 has a rectangular shape as a whole, preferably, openings 22c are provided at positions corresponding to side portions 21c opposite each other among the side portions 21c of the optical, element stack 21. FIGS. 28A and 28B show an example in which openings 22c are provided at the positions corresponding to all the side portions 21c of the optical element stack 21. The size and shape of the openings 22c are preferably selected in consideration of the air discharge performance during the manufacturing process of the optical package 2, the shape of the optical element stack 21, the durability of the packaging member 22, etc. For example, the openings 22c have a slit-like shape as shown in FIGS. 28A and 28B. However, the shape is not limited thereto, and may be circular, elliptic, semi-circular, triangular, quadrangular, rhombic, or the like.

### EXAMPLES

The present application will be described below based on examples according to an embodiment However, it is to be understood that the present application is not limited to the examples.

Samples 1 to 37 will be described below with reference to Table 1.

TABLE 1

| | | | Irregular | | | | |
|---|---|---|---|---|---|---|---|
| | | | layer | Filler | | | |
| | Binder | | Coating | | Particle | | |
| | | Thickness | thickness | | diameter | | Irregularities |
| | Type | [μm] | [μm] | Type | [μm] | Amount of addition | on surface |
| Sample 1 | PP/PE- | 30 | None | PMMA | φ5 | First surface layer 4 mass % | Present |
| Sample 2 | based | | None | | | First surface layer 5 mass % | Present |
| Sample 3 | | | None | | | First surface layer 7 mass % | Present |
| Sample 4 | | | None | | | First surface layer 20 mass % | Present |
| Sample 5 | | | None | PMMA | φ8 | First surface layer 4 mass % | Present |
| Sample 6 | | | None | | | First surface layer 5 mass % | Present |
| Sample 7 | | | None | | | First surface layer 20 mass % | Present |
| Sample 8 | | | None | | | Base material layer 10 mass % | Absent |
| Sample 9 | | | None | | | Base material layer 15 mass % | Absent |
| Sample 10 | | | None | | | Base material layer 20 mass % | Absent |
| Sample 11 | | | None | | | First surface layer 10 mass % | Present |
| | | | | | | Base material layer 5 mass % | |
| Sample 12 | | | None | | | First surface layer 10 mass % | Present |
| | | | | | | Base material layer 10 mass % | |
| Sample 13 | | | None | PSt | φ8 | Base material layer 10 mass % | Absent |
| Sample 14 | | | None | | | First surface layer 10 mass % | Present |
| | | | | | | Base material layer 5 mass % | |
| Sample 15 | | | None | | | First surface layer 10 mass % | Present |
| | | | | | | Base material layer 10 mass % | |
| Sample 16 | | | None | | | Base material layer 20 mass % | Absent |
| Sample 17 | | | None | | | First surface layer 20 mass % | Present |
| Sample 18 | | | None | CaCO₃ | 0.5 to 5 | Base material layer 4 mass % | Present (small |
| | | | | | Not regular | | amount) |
| Sample 19 | | | None | | | Base material layer 5 mass % | Present (small |
| | | | | | | | amount) |
| Sample 20 | | | None | TiO₂ | φ0.4 | Base material layer 3 mass % | Absent |
| Sample 21 | | | None | | on average | Base material layer 4 mass % | Absent |
| Sample 22 | | | None | | | Base material layer 5 mass % | Absent |
| Sample 23 | | | None | | | Base material layer 7 mass % | Absent |
| Sample 24 | | | None | | | Base material layer 10 mass % | Absent |
| Sample 25 | | | None | | | Base material layer 15 mass % | Absent |
| Sample 26 | | | None | | | Base material layer 18 mass % | Absent |
| Sample 27 | | | None | | | Base material layer 20 mass % | Absent |
| Sample 28 | | | None | SiO₂ | 1 to 2 | Base material layer 5 mass % | Absent |
| | | | | | Rectangular | | |
| Sample 29 | PP/PE- | 30 | 2 | PMMA | φ5 | Filler (parts by weight)/Binder (parts | Present |
| Sample 30 | based | | 4 | | | by weight) = 0.3 | Present |
| Sample 31 | | | 8 | | | | Present |
| Sample 32 | | | 2 | | | Filler (parts by weight)/Binder (parts | Present |
| Sample 33 | | | 4 | | | by weight) = 1.4 | Present |
| Sample 34 | | | 8 | | | | Present |
| Sample 35 | PET | 200 | 10 | PMMA | φ2 to 10 | Filler (parts by weight)/Binder (parts | Present |
| | | | | | | by weight) = 0.3 or less | |
| Sample 36 | PET | 188 | 15 | PMMA | φ3 to 10 | Filler (parts by weight)/Binder (parts | Present |
| | | | | | | by weight) = 0.3 to 1.4 | |
| Sample 37 | PET | 200 | 10 | PMMA | φ3 to 20 | Filler (parts by weight)/Binder (parts | Present |
| | | | | | | by weight) = about 1.4 | |

### (Sample 1)

### [Formation of Packaging Member]

First, a composition containing polypropylene as a major component, a composition containing polyethylene-polypropylene as a major component, and a composition containing poly propylene as a major component were coextruded and sequentially biaxially stretched by stretching in the machine direction and then stretching in a direction (in the width direction) perpendicular to the machine direction. Thereby, an olefin-based shrink film composed of polypropylene/polyethylene-polypropylene/polypropylene was obtained. To the composition for forming a first surface layer, a filler composed of an acrylic resin containing polymethyl methacrylate (PMMA) having an average particle diameter of 5 μm as a major component was added in an amount of 4% by mass relative to the amount of the first surface layer (total of the binder and the filler). Subsequently, the olefin-based shrink film obtained after stretching was subjected to heat-setting treatment Thereby, a first packaging member on the light-incident surface side and a second packaging member on the light-emitting surface side, each including the first surface layer containing voids and a filler disposed in the voids and having irregularities on the surface, a base material layer, and a second surface layer, were obtained. The thickness of the first surface layer was 7 to 8 μm, the thickness of the base material layer was 15 μm, the thickness of the second surface layer was 7 to 8 μm, and the total thickness was 30±2 μm.

### [Evaluation of Heat Shrinkage Property]

A film with a size of 300 mm×300 mm was cut out from each of the resulting first packaging member and the resulting second packaging member, using a carpenter's square. With respect to the cut-out films, the heat shrinkage after treatment at 100° C. for 10 minutes by a blow dryer was measured. The results show that the shrinkage of each of the first packaging member and the second packaging member was 12% in one stretching direction and 15% in a stretching direction perpendicular thereto. As is evident from the results, each of the first packaging member and the second packaging member has a heat shrinkage property.

[Optical properties of Packaging Member]

With respect to the first packaging member and the second packaging member, the optical properties were checked. The measurement was carried out using a haze meter (HM-150) manufactured by Murakami Color Research Laboratory. The haze value was measured according to JIS-K-7136. The total light transmittance was measured according to JIS-K-7316. The results thereof are shown in Table 2.

### [Production of Optical Package]

As a support, a diffuser plate (2 mm×500 mm×890 mm) containing polycarbonate as a major component was prepared, and a commercially available diffuser film (manufactured by Keiwa Inc., BS-912: 205 μm×498 mm×888 mm) and a commercially available lens sheet (manufactured by SONY Corporation, polycarbonate resin, lens pitch 185 μm, hyperboloidal shape, size 450 μm×498 mm×888 mm) were prepared. Next, the diffuser plate, the diffuser film, and the lens sheet were stacked in that order to form an optical element stack. The optical element stack was placed on the first packaging member such that the diffuser plate side was the bottom side, and the second packaging member was placed thereon. The first packaging member and the second packaging member were joined by thermowelding at four sides and cut by fusing such that the overall size was 540 mm×950 mm. Then, a plurality of air discharging holes with a diameter of 0.5 mm were formed on the end portions of the first packaging member and the second packaging member.

Next, the optical element stack covered with the first packaging member and the second packaging member was heated in a blow dryer at 100° C. Thereby, the first packaging member and the second packaging member were subjected to heat shrinkage so as to cover the optical element stack, under shrinkage force. In this stage, while discharging air from the holes provided in the end portions of the first packaging member and the second packaging member, cooling was performed to bring the optical element stack into close contact with the first packaging member and the second packaging member. An optical package was thereby obtained.

### [Evaluation of Luminance]

Optical elements, such as a diffuser plate, were removed from a 40-inch liquid crystal TV manufactured by SONY Corporation as a large-size liquid crystal television evaluation machine, and, instead of the optical elements, the optical package obtained as described above was mounted on the liquid crystal TV. In this stage, the liquid crystal panel was left to be removed. The liquid crystal TV was turned on, and the luminance at 45° was measured by a spectral luminance meter (trade name: Ez-contrast, manufactured by ELDIM) in which the front luminance (0°) of the optical element stack of the liquid crystal display was normalized as 1. The result thereof is shown in Table 2.

### (Sample 2)

A first packaging member and a second packaging member were obtained as in Sample 1 except that, in the formation of the packaging member, to one composition for forming the first surface layer, a filler containing PMMA having an average particle diameter of 5 μm as a major component was added in an amount of 5% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 3)

A first packaging member and a second packaging member were obtained as in Sample 1 except that, in the formation of the packaging member, to one composition for forming the first surface layer, a filler containing PMMA having an average particle diameter of 5 μm as a major component was added in an amount of 7% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 4)

A first packaging member and a second packaging member were obtained as in Sample 1 except that, in the formation of the packaging member, to one composition for forming the first surface layer, a filler containing PMMA having an average particle diameter of 5 μm as a major component was added in an amount of 20% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 5)

A first packaging member and a second packaging member were obtained as in Sample 1 except that, in the formation of the packaging member, to one composition for forming the first surface layer, a filler containing PMMA having an average particle diameter of 8 μm as a major component was added in an amount of 4% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 6)

A first packaging member and a second packaging member were obtained as in Sample 1 except that, in the formation of the packaging member, to one composition for forming the first surface layer, a filler containing PMMA having an average particle diameter of 8 μm as a major component was added in an amount, of 5% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 7)

A first packaging member and a second packaging member were obtained as in Sample 1 except that, in the formation of the packaging member, to one composition for forming the first surface layer, a filler containing PMMA having an average particle diameter of 8 μm as a major component was added in an amount of 20% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 8)

A first packaging member and a second packaging member, each including a first surface layer, a base material layer containing voids and a filler disposed in the voids, and a second surface layer, were obtained as in Sample 1 except that, in the formation of the packaging member, no filler was added to one composition for forming the first surface layer, and to the composition for forming the base material layer, a filler containing PMMA having an average particle diameter of 8 μm as a major component was added in an amount of 10% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 9)

A first packaging member and a second packaging member, each including a first surface layer, a base material layer containing voids and a tiller disposed in the voids, and a second surface layer, were obtained as in Sample 1 except that, in the formation of the packaging member, no filler was added to one composition for forming the first surface layer, and to the composition for forming the base material layer, a filler containing PMMA having an average particle diameter of 8 μm as a major component was added in an amount of 15% by mass relative to the total amount, of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 10)

A first packaging member and a second packaging member, each including a first surface layer, a base material layer containing voids and a tiller disposed in the voids, and a second surface layer, were obtained as in Sample 1 except that, in the formation of the packaging member, no filler was added to one composition for forming the first surface layer, and to the composition for forming the base material layer, a filler containing PMMA having an average particle diameter of 8 μm as a major component was added in an amount of 20% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 11)

In the formation of the packaging member, to one composition for forming the first surface layer, a filler containing PMMA having an average particle diameter of 8 μm as a major component was added in an amount of 10% by mass relative to the total amount of the first surface layer (total of the binder and the filler). To the composition for forming the base material layer, a filler containing PMMA having an average particle diameter of 8 μm as a major component was added in an amount of 5% by mass relative to the total amount of the base material layer (total of the binder and the filler). Except for those described above, as in Sample 1, a first packaging member and a second packaging member, each including a first surface layer containing voids and the filler disposed in the voids and having irregularities on the surface thereof a base material layer containing voids and the filler disposed in the voids, and a second surface layer, were obtained. Then, the optical properties and luminance of the packaging member were evaluated as in Sample 1 except for the use of the first packaging member and the second packaging member. The results thereof are shown in Table 2.

### (Sample 12)

In the formation of the packaging member, to one composition for forming the first surface layer, a filler containing PMMA having an average particle diameter of 8 μm as a major component was added in an amount of 10% by mass relative to the total amount of the first surface layer (total, of the binder and the filler). To the composition for forming the base material layer, a filler containing PMMA having an average particle diameter of 8 μm as a major component was added in an amount of 10% by mass relative to the total amount of the base material layer (total of the binder and the filler). Except for those described above, as in Sample 1, a first packaging member and a second packaging member, each including a first surface layer having irregularities on the surface thereof, a base material layer containing voids and a filler disposed in the voids, and a second surface layer, were obtained. Then, the optical properties and luminance of the packaging member were evaluated as in Sample 1 except for the use of the first packaging member and the second packaging member. The results thereof are shown in Table 2.

### (Sample 13)

A first packaging member and a second packaging member, each including a first surface layer, a base material layer containing voids and a filler disposed in the voids, and a second surface layer, were obtained as in Sample 1 except that, in the formation of the packaging member, no filler was added to one composition for forming the first surface layer, and to the composition for forming the base material layer, a filler containing polystyrene (PSt) having an average particle diameter of 8 μm as a major component was added in an amount of 10% by mass relative, to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 14)

In the formation of the packaging member, to one composition for forming the first surface layer, a filler containing PSt having an average particle diameter of 8 μm as a major component was added in an amount of 10% by mass relative to the total amount of the first surface layer (total of the binder and the filler). To the composition for forming the base material layer, a filler containing PSt having an average particle diameter of 8 μm as a major component was added in an amount of 5% by mass relative to the total amount of the base material layer (total of the binder and the filler). Except for those described above, as in Sample 1, a first packaging member and a second packaging member, each including a first surface layer containing voids and the filler disposed in the voids and having irregularities on the surface thereof a base material layer containing voids and the filler disposed in the voids, and a second surface layer, were obtained. Then, the optical properties and luminance of the packaging member were evaluated as in Sample 1 except for the use of the first packaging member and the second packaging member. The results thereof are shown in Table 2.

### (Sample 15)

In the formation of the packaging member, to one composition for forming the first surface layer, a filler containing PSt having an average particle diameter of 8 μm as a major component was added in an amount of 10% by mass relative to the total amount of the first surface layer (total of the binder and the filler). To the composition for forming the base material layer, a filler containing PSt having an average particle diameter of 8 μm as a major component was added in an amount of 10% by mass relative to the total amount of the base material layer (total of the binder and the filler). Except, for those described above, as in Sample 1, a first packaging member and a second packaging member, each including a first surface layer containing voids and the tiller disposed in the voids and having irregularities on the surface thereof, a base material layer containing voids and the filler disposed in the voids, and a second surface layer, were obtained. Then, the optical properties and luminance of the packaging member were evaluated as in Sample 1 except for the use of the first packaging member and the second packaging member. The results thereof are shown in Table 2.

### (Sample 16)

A first packaging member and a second packaging member, each including a first surface layer, a base material layer containing voids and a filler disposed in the voids, and a second surface layer, were obtained as in Sample 1 except that, in the formation of the packaging member, no filler was added to one composition for forming the first surface layer, and to the composition for forming the base material layer, a filler containing PSt having an average particle diameter of 8 μm as a major component was added in an amount of 20% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 17)

A first packaging member and a second packaging member were obtained as in Sample 1 except that, in the formation of the packaging member, to one composition for forming the first surface layer, a filler containing PSt having an average particle diameter of 8 μm as a major component was added in an amount of 20% by mass relative to the total amount of the first surface layer (total of the binder and the filler). Then, the optical properties and luminance of the packaging member were evaluated as in Sample 1 except for the use of the first packaging member and the second packaging member. The results thereof are shown in Table 2.

### (Sample 18)

A first packaging member and a second packaging member, each including a first surface layer, a base material layer containing voids and a filler disposed in the voids, and a second surface layer, were obtained as in Sample 1 except, that, in the formation of the packaging member, no filler was added to one composition for forming the first surface layer, and to the composition for forming the base material layer, a filler composed of calcium carbonate (CaCO₃) having a size of 0.5 to 5 μm was added in an amount of 4% by mass relative to the total amount of the base material layer (total of the binder and the filler). A small amount of irregularities was formed on each of the surface of the first packaging member and the surface of the second packaging member. Then, the optical properties and luminance of the packaging member were evaluated as in Sample 1 except for the use of the first packaging member and the second packaging member. The results thereof are shown in Table 2.

### (Sample 19)

A first packaging member and a second packaging member, each including a first surface layer, a base material layer containing voids and a filler disposed in the voids, and a second surface layer, were obtained as in Sample 1 except that, in the formation of the packaging member, no filler was added to one composition for forming the first surface layer, and to the composition for forming the base material layer, a filler composed of CaCO₃ having a size of 0.5 to 5 μm was added in an amount of 5% by mass relative to the total amount of the base material layer (total of the binder and the filler). A small amount of irregularities was formed on each of the surface of the first packaging member and the surface of the second packaging member. Then, the optical properties and luminance of the packaging member were evaluated as in Sample 1 except for the use of the first packaging member and the second packaging member. The results thereof are shown in Table 2.

### (Sample 20)

A first packaging member and a second packaging member were obtained as in Sample 1 except that, in the formation of the packaging member, no filler was added to one composition for forming the first surface layer, and to the composition for forming the base material layer, a filler composed of titanium oxide (TiO₂) having an average particle diameter of 0.4 μm was added in an amount, of 3% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 21)

A first packaging member and a second packaging member were obtained as in Sample 1 except that, in the formation of the packaging member, no filler was added to one composition for forming the first surface layer, and to the composition for forming the base material layer, a filler composed of titanium oxide (TiO₂) having an average particle diameter of 0.4 μm was added in an amount of 4% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 22)

A first packaging member and a second packaging member were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 5% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 23)

A first packaging member and a second packaging member, each including a first surface layer, a base material layer containing voids and a filler disposed in the voids, and a second surface layer, were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 7% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 24)

A first packaging member and a second packaging member, each including a first surface layer, a base material layer containing voids and a filler disposed in the voids, and a second surface layer, were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 10% by mass relative to the total amount, of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 25)

A first packaging member and a second packaging member, each including a first surface layer, a base material layer containing voids and a filler disposed in the voids, and a second surface layer, were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 15% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 26)

A first packaging member and a second packaging member, each including a first surface layer, a base material layer containing voids and a filler disposed in the voids, and a second surface layer, were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 18% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 27)

A first packaging member and a second packaging member, each including a first surface layer, a base material layer containing voids and a filler disposed in the voids, and a second surface layer, were obtained as in Sample 1 except that no filler was added to one composition for forming the first surface layer, and to the composition for forming the base material layer, a filler composed of titanium oxide (TiO₂) having an average particle diameter of 0.4 μm was added in an amount of 20% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 28)

A first packaging member and a second packaging member, each including a first surface layer, a base material layer containing voids and a filler disposed in the voids, and a second surface layer, were obtained as in Sample 1 except that, in the formation of the packaging member, no filler was added to one composition for forming the first surface layer, and to the composition for forming the base material layer, a filler composed of silicon oxide (SiO₂) having a size of 1 to 2 μm was added in an amount of 5% by mass relative to the total amount of the base material layer (total of the binder and the filler). No irregularities were formed on the surfaces of the first packaging member and the second packaging member. Then, the optical properties and luminance of the packaging member were evaluated as in Sample 1 except for the use of the first packaging member and the second packaging member. The results thereof are shown in Table 2.

### (Sample 29)

### [Formation of Packaging Member]

As in Sample 1, a first packaging member on the light-incident surface side and a second packaging member on the light-emitting surface side, each having a thickness of 30 μm, were obtained. Then, an irregular layer having diffusing properties was formed on the second packaging member by the method described below. First, the raw materials in the coating material composition shown below were prepared and mixed with a disperser for 3 hours. Thereby, a coating material having diffusing properties was obtained. Then, the second packaging member was subjected to adhesion facilitation treatment by corona discharge, and the adjusted coating material having diffusing properties was applied to a principal surface of the second packaging member by a gravure coating method, followed by smoothing and drying at a maximum dryer temperature of 70° C. Thereby, the second packaging member provided with an irregular layer with a coating thickness of 2 μm on the surface thereof was obtained. The coating thickness of the irregular layer was calculated by observing a cross-section of the second packaging member with a scanning electron microscope (SEM).

### <Raw Materials: Composition Ratio>

Acrylic resin, containing PMMA as major component: 100 parts by weight.

Filler containing PMMA as major component (diameter 5 μm, spherical core): 30 parts by weight

Methyl ethyl ketone solvent: 300 parts by weight

### [Evaluation of Heat Shrinkage Property]

With respect to the second packaging member provided with the irregular layer obtained as described above, the heat shrinkage was measured as in Sample 1. The results show that the shrinkage of the second packaging member after heat treatment was 11% in one stretching direction and 13% in a stretching direction perpendicular thereto. As is evident from the results, the second packaging member provided with the irregular layer has a heat shrinkage property in the same manner as before being provided with the irregular layer.

Then, the optical properties and luminance of the optical packaging member were evaluated as in Sample 1 except for the use of the first packaging member and the second packaging member. The results thereof are shown in Table 2.

### (Sample 30)

A second packaging member was obtained as in Sample 29 except that, in the formation of the packaging member, an irregular layer with a coating thickness of 4 μm was formed on the surface thereof. Then, the optical properties and luminance of the packaging member were evaluated as in Sample 1 except for the use of the first packaging member and the second packaging member. The results thereof are shown in Table 2.

### (Sample 31)

A second packaging member was obtained as in Sample 29 except that, in the formation of the packaging member, a light diffusion layer with a coating thickness of 8 μm was formed on the surface thereof. Then, the optical properties and luminance of the packaging member were evaluated as in Sample 1 except for the use of the first packaging member and the second packaging member. The results thereof are shown in Table 2.

### (Sample 32)

A second packaging member was obtained as in Sample 29 except that, in the formation of the packaging member, the amount, of acrylic beads added was set at 140 parts by weight. Then, the optical properties and luminance of the packaging member were evaluated as in Sample 1 except for the use of the first packaging member and the second packaging member. The results thereof are shown in Table 2.

### (Sample 33)

A second packaging member was obtained as in Sample 32 except that, in the formation of the packaging member, a light diffusion layer with a coating thickness of 4 μm was formed on the surface thereof Then, the optical properties and luminance of the packaging member were evaluated as in Sample 1 except for the use of the first packaging member and the second packaging member. The results thereof are shown in Table 2.

### (Sample 34)

A second packaging member was obtained as in Sample 32 except that, in the formation of the packaging member, a light diffusion layer with a coating thickness of 8 μm was formed on the surface thereof. Then, the optical properties and luminance of the packaging member were evaluated as in Sample 1 except for the use of the first packaging member and the second packaging member. The results thereof are shown in Table 2.

### (Sample 35)

A commercially available diffuser film with a thickness of 200 μm was prepared, the diffuser film, containing a filler having PMMA as a major component and a binder having polyethylene terephthalate (PET) as a major component. The amount of the filler added was 30 parts by weight or less relative to 100 parts by weight of the binder. The filler had an average particle diameter of 2 to 10 μm. No voids were formed in the diffuser film. Then, the optical properties of the diffuser film were evaluated as in Sample 1. The results thereof are shown in Table 2.

### [Production of Optical Stack]

An optical element stack, obtained as in Sample 1 was placed such that the diffuser plate side was the bottom side, and the prepared diffuser film was placed thereon. Thereby, an optical element stack was obtained.

### [Evaluation of Luminance]

Optical elements, such as a diffuser plate, were removed from a 40-inch liquid crystal TV manufactured by SONY Corporation as a large-size liquid crystal television evaluation machine, and, instead of the optical elements, the optical element stack obtained as described above was mounted on the liquid crystal TV. Other than this, as in Sample 1, the luminance at 45° was measured in the case where the front luminance (0°) was normalized as 1. The result thereof is shown in Table 2.

### (Sample 36)

A commercially available diffuser film with a thickness of 188 μm was prepared, the diffuser film containing a filler having PMMA as a major component and a binder having PET as a major component. The amount of the filler added was about middle of the range from 30 to 140 parts by weight relative to 100 parts by weight of the binder. The filler had an average particle diameter of 3 to 10 μm. No voids were formed in the diffuser film. Other than this, as in Sample 35, the optical properties and luminance of the diffuser film were evaluated. The results thereof are shown in Table 2.

### (Sample 37)

A commercially available diffuser film with a thickness of 200 μm was prepared, the diffuser film being provided with an irregular layer on the surface thereof and containing a binder having PET as a major component, the irregular layer containing a filler having PMMA as a major component. The coating thickness of the irregular layer was 10 ∥m. In the irregular layer, the amount of the filler added was about 140 parts by weight relative to 100 parts by weight of the binder. The filler had an average particle diameter of 3 to 20 μm. No voids were formed in the diffuser film. Other than this, as in Sample 35, the optical properties and luminance of the diffuser film were evaluated. The results thereof are shown in Table 2.

TABLE 2

| | Luminance at 45° in the case | | |
|---|---|---|---|
| | where front luminance (0°) was | Transmittance (τt) | Haze |
| | normalized as 1 | [%} | [%] |
| Sample 1 | 0.183 | 90.3 | 20.2 |
| Sample 2 | 0.201 | 87.6 | 23.8 |
| Sample 3 | 0.219 | 86.7 | 33.2 |
| Sample 4 | 0.469 | 68.8 | 76.1 |
| Sample 5 | 0.182 | 89.5 | 17.1 |
| Sample 6 | 0.209 | 87.1 | 26.8 |
| Sample 7 | 0.336 | 73.7 | 65.4 |
| Sample 8 | 0.169 | 90.4 | 24.0 |
| Sample 9 | 0.462 | 82.9 | 72.9 |
| Sample 10 | 0.556 | 68.5 | 92.3 |
| Sample 11 | 0.179 | 91.0 | 19.9 |
| Sample 12 | 0.184 | 90.2 | 26.9 |
| Sample 13 | 0.186 | 91.2 | 39.9 |
| Sample 14 | 0.196 | 91.2 | 37.9 |
| Sample 15 | 0.212 | 91.1 | 55.2 |
| Sample 16 | 0.220 | 90.6 | 65.6 |
| Sample 17 | 0.227 | 91.0 | 44.3 |
| Sample 18 | 0.266 | 90.1 | 56.1 |
| Sample 19 | 0.289 | 89.8 | 57.0 |
| Sample 20 | 0.348 | 82.0 | 39.7 |
| Sample 21 | 0.427 | 80.0 | 43.9 |
| Sample 22 | 0.501 | 74.4 | 58.4 |
| Sample 23 | 0.670 | 68.6 | 71.2 |
| Sample 24 | 0.763 | 61.8 | 85.1 |
| Sample 25 | 0.879 | 54.4 | 93.9 |
| Sample 26 | 0.921 | 45.7 | 99.0 |
| Sample 27 | 0.944 | 40.9 | 99.4 |
| Sample 28 | 0.167 | 91.9 | 18.9 |
| Sample 29 | 0.295 | 88.2 | 80.6 |
| Sample 30 | 0.280 | 84.3 | 63.5 |
| Sample 31 | 0.225 | 84.5 | 37.2 |
| Sample 32 | 0.329 | 73.9 | 73.7 |
| Sample 33 | 0.368 | 76.4 | 95.0 |
| Sample 34 | 0.387 | 73.3 | 96.2 |
| Sample 35 | 0.236 | 92.0 | 57.5 |
| Sample 36 | 0.330 | 87.8 | 89.6 |
| Sample 37 | 0.355 | 67.6 | 93.0 |

### [Evaluation of Results]

In Table 2, if the luminance at 45°, in the case where the front luminance (0°) is normalized as 1, is 0.280 to 0.355, the luminance non-uniformity is small and a good viewing angle is obtained. Furthermore, if the haze value is 40 or more, the luminance non-uniformity is small and a good viewing angle is obtained. Furthermore, in Table 1, the filler in Samples 29 to 34 refers to the filler in the irregular layer.

Samples 1 to 34, in which the packaging member including voids and the filler disposed in the voids was used, had substantially the same viewing angle as Samples 35 to 37 in which the diffuser film with larger thickness was used. That is, in Samples 1 to 34, since desired optical properties can be obtained without increasing the number of diffuser films, the overall thickness can be decreased significantly. Furthermore, in Samples 1 to 28, in which the amount of the filler added is small compared with Samples 35 to 37, and in Samples 8 to 10 and Sample 13, etc., in which, surface irregularities are absent, high luminance and high haze value can be obtained.

As shown in Samples 1 to 4 and Samples 5 to 7, in the packaging member provided with the first surface layer including voids and the filler disposed in the voids, when the amount of the filler added was increased, the luminance at 45° improved (in the case where the front luminance (0° C.) was normalized as 1), the transmittance of the packaging member decreased, and the haze value increased. Furthermore, as shown in Samples 8 to 28, in the packaging member provided with the base material layer including voids and the filler disposed in the voids and in the packaging member provided with the first surface layer including voids and the filler disposed in the voids and the base material layer including voids and the filler disposed in the voids, the same results were obtained. Furthermore, in Samples 29 to 34, in which the irregular layer having diffusing properties was disposed on the surface, better results were obtained in terms of the luminance at 45° improved (in the case where the front luminance (0° C.) was normalized as 1) and the haze value, and thus it was evident that the luminance non-uniformity can be further decreased and a better viewing angle can be obtained.

The above results confirm that, by using an optical package in which an optical element stack is covered with a packaging member including voids and a filler disposed in the voids, advantages described below can be obtained.

Since the packaging member has the same function as a diffuser film, not only the packaging member can be used as a replacement for a diffuser film, but also the optical element stack can be simplified. Therefore, the thickness of the whole optical package can be decreased, and the weight of the optical package can be decreased. Consequently, necessary optical properties can be obtained without increasing the number of optical elements even in the case where light source non-uniformity tends to occur with a decrease in the thickness of backlights.

Furthermore, since the optical element stack is covered with the packaging member in the presence of applied tension, even if the thickness of the packaging member is small, for example, at several tens of micrometers, it is possible to prevent, the occurrence of wrinkles, looseness, and warpage in the first region R₁ and the second region R₂ of the optical package, thus planarizing the first region R₁ and the second region R₂. The influence of luminance non-uniformity due to deflection or the like can be alleviated.

It is to be understood that the present application is not limited to the embodiments described above, and various modifications are possible without departing from the spirit of the present application.

The structures in the embodiments described above can be combined without departing from the scope of the present application.

For example, the numerical values stated in the embodiments are merely examples, and different numerical values may be used as necessary.

In the first embodiment, the structure is employed in which at least one of the first surface layer and the base material layer includes voids and a filler disposed in the voids However, a structure may also be employed in which the second surface layer includes voids and a filler disposed in the voids.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical package comprising:
one or more optical elements;
a support which supports the one or more optical elements: and
a packaging member which covers the one or more optical elements and the support,
wherein the one or more optical elements and the support form a stack,
the stack and the packaging member are in close contact with each other, and
the packaging member has a shrinkage property or a stretching property and contains voids and a filler disposed in the voids.

2. The optical package according to Claim 1, wherein the stack has a light-incident surface on which light from a light source is incident, a light-emitting surface from which the light incident on the light-incident surface is emitted, and end feces located between the light-incident surface and the light-emitting surface, and
the packaging member covers the light-emitting surface, the light-incident surface, and all the end faces of the stack.

3. The optical package according to claim 1, wherein the packaging member has an opening in the periphery thereof.

4. The optical package according to claim 3, wherein the opening is disposed at the position corresponding to a corner portion or a side portion of the stack.

5. The optical package according to claim 1, wherein the packaging member having the shrinkage property has at least one of a heat shrinkage property and an energy ray irradiation shrinkage property.

6. The optical package according to claim 1, wherein the packaging member has a first region on which light from a light source is incident and a second region on which light transmitted through the first region and then through the support is incident, and
the voids and the filler are contained in at least one of the first region and the second region.

7. The optical package according to claim 1, wherein the packaging member includes a base material layer and a surface layer disposed on a surface of the base material layer, and
at least one of the base material layer and the surface layer contains the voids and the filler.

8. The optical package according to claim 1, wherein the packaging member has an irregular shape on a surface thereof.

9. The optical package according to claim 8, wherein the irregular shape is formed by embossing.

10. The optical package according to claim 8, wherein the irregular shape is formed by protrusion of the filler from the surface of the packaging member.

11. The optical package according to claim 1, wherein the packaging member is monoaxially or biaxially stretched,

12. The optical package according to claim 1, wherein the filler is composed of at least one of organic particles and inorganic particles.

13. The optical, package according to claim 12, wherein the organic particles and the inorganic particles are hollow particles.

14. An optical package comprising:
a support that has a plate configuration; and
a packaging member which covers the support, wherein the packaging member has a film configuration or a sheet configuration
wherein the packaging member and the support are in close contact with each other, and
the packaging member has a shrinkage property or a stretching property and contains voids and a filler disposed in the voids.

15. The optical package according to claim 14, wherein the support, is an optical element, that has a plate configuration.

16. A method of manufacturing an optical package comprising:
forming a packaging member which contains a binder and a filler;
forming voids in the packaging member so that the voids include the filler by stretching the packaging member;
covering a stack including one or more optical elements and a support with the stretched packaging member; and
bringing the stack and the packaging member into close contact with each other by shrinking the packaging member.

17. The method of manufacturing an optical package according to claim 16, further comprising forming a surface layer by applying a coating material containing a binder and a filler onto the packaging member and curing the coating material so that the filler protrudes from the surface layer.

18. The method of manufacturing an optical package according to claim 16, further comprising embossing a surface of the packaging member.

19. The method of manufacturing an optical package according to claim 16, wherein the packaging member is caused to shrink by heat shrinkage or energy ray irradiation.

20. A method of manufacturing an optical package comprising:
forming a packaging member which contains a binder and a filler, wherein the packaging member has a film configuration and a sheet configuration;
forming voids in the packaging member so that the voids include the filler by stretching the packaging member;
covering a support with the stretched packaging member wherein the support has a plate configuration; and
bringing the support and the packaging member into close contact with each other by shrinking the packaging member.

21. A backlight comprising:
a light source which emits light; and
an optical package through which the light emitted from the light source is transmitted,
wherein the optical package includes
one or more optical elements,
a support which supports the one or two or more optical elements, and
a packaging member which covers the one or more optical elements and the support,
wherein the one or more optical elements and the support form a stack,
the stack and the packaging member are in close contact with each other, and
the packaging member has a shrinkage property or a stretching property and contains voids and a filler disposed in the voids.

22. A backlight, comprising:
a light, source which emits light; and
an optical package through which the light emitted from the light source is transmitted,
wherein the optical package includes
a support that, has a plate, and
a packaging member which covers the support, wherein the packaging member has a film configuration or a sheet configuration,
wherein the packaging member and the support are in close contact with each other, and
the packaging member has a shrinkage property or a stretching property and contains voids and a filler disposed in the voids.

23. A liquid crystal display comprising:
a light source which emits light;
an optical package through which the light emitted from the light source is transmitted; and
a liquid crystal panel which displays an image on the basis of the light transmitted through the optical package,
wherein the optical package includes
one or more optical elements,
a support which supports the one or more optical elements, and
a packaging member which covers the one or more optical elements and the support,
wherein the one or more optical elements and the support form a stack,
the stack and the packaging member are in close contact with each other, and
the packaging member has a shrinkage property or a stretching property and contains voids and a filler disposed in the voids.

24. A liquid crystal display comprising:
a light source which emits light;
an optical package through which the light emitted from the light source is transmitted, and
a liquid crystal panel which displays an image on the basis of the light transmitted through the optical package,
wherein the optical package includes
a support, that, has a plate configuration, and
a packaging member which covers the support, wherein the packaging member has a film configuration and a sheet configuration,
wherein the packaging member and the support are in close contact with each other, and
the packaging member has a shrinkage property or a stretching property and contains voids and a filler disposed in the voids.
